(19) United States
(12) Patent Application Publication
(10) Pub. No.: US 2018/0140128 A1
(43) Pub. Date: May 24, 2018

(54) STIRRING ELEMENT AND STIRRING DEVICE

(71) Applicant: Sharp Kabushiki Kaisha, Sakai City, Osaka (JP)

(72) Inventors: Masaaki KODAMA, Sakai City (JP); Toshinori OKADA, Sakai City (JP); Daisuke TAKAHASHI, Sakai City (JP); Norio KANETSUKI, Sakai City (JP); Shinji NAGAI, Sakai City (JP); Daiki ENDO, Sakai City (JP); Hitoshi KIJI, Sakai City (JP); Motoyasu YOSHII, Sakai City (JP)

(21) Appl. No.: 15/571,863

(22) PCT Filed: May 16, 2016
(86) PCT No.: PCT/JP2016/064415

§ 371 Date: Nov. 6, 2017

(30) Foreign Application Priority Data
May 18, 2015 (JP) 2015-101123
Apr. 28, 2016 (JP) 2016-090664

(51) Int. Cl. A47J 31/40; A47J 31/44; A47J 43/07

(52) U.S. Cl. CPC A47J 31/401; B01F 13/08; A47J 43/0711; A47J 31/4403

(57) ABSTRACT

A disc-shaped stirring element (100A) includes at least one projecting portion (102) at a position on a lower surface (103a) separated from a rotation center, the projecting portion (102) projecting toward a bottom surface (51a) of a stirring container (51), and an upper surface (103b) of the stirring element (100A) is planar.

### TECHNICAL FIELD

The present invention relates to a disc-shaped stirring element that is to be placed on a bottom portion of a stirring container for stirring a liquid and to a stirring device including the stirring container and the stirring element. In particular, the present invention relates to a stirring element, a stirring container, and a beverage generating device that prepares a liquid mixture by mixing a mixture material and a liquid.

### BACKGROUND ART

In recent years, WHO (World Health Organization) and FAO (Food and Agriculture Organization of the United Nations) have jointly issued “Safe preparation, storage and handling of powdered infant formula: guidelines”.

According to the guidelines, it is reported that powdered infant formula, that is, powdered infant milk has been associated with serious illness and death in infants due to infections with Enterobacter sakazakii and the like.

It is reported that, in order to prevent the infections, it is necessary to prepare a feed by reconstituting powdered infant formula with boiled water at a temperature of no less than 70° C. The guidelines describe the following method as a practical method for preparing a feed.

(1) Clean and disinfect a surface on which to prepare a feed using powdered infant formula (powdered milk).
(2) Wash hands with soap and clean water, and dry using a clean cloth or a single-use napkin.
(3) Boil a sufficient volume of safe water.
(4) Taking care to avoid scalds, pour the appropriate amount of boiled water, which has been cooled to not below 70° C., into a cleaned and sterilized cup or bottle.
(5) Add the exact amount of formula as instructed on the label.
(6) Cool feeds quickly to feeding temperature by holding under a running tap, or placing in a container of cold water or iced water.
(7) Dry the outside of the feeding cup or the feeding bottle with a clean or disposable cloth and label with appropriate information, such as type of formula, infant's name or ID, time and date prepared, and preparer's name.
(8) Because very hot water has been used to prepare the feed, it is essential that the feeding temperature is checked before feeding in order to avoid scalding the infant's mouth.
(9) Discard any feed that has not been consumed within two hours.

The appropriate feeding temperature of milk is about 40° C., which is near the body temperature, in consideration of the temperature of breast milk, the body temperature, and the like. Therefore, in order to prepare infant milk using powdered infant formula, it is necessary to prepare a feed by reconstituting the powdered infant formula with a liquid that has been once boiled and that has a temperature of no less than 70° C. and then to cool the milk to a temperature of about 40° C.

Some existing beverage generating devices, such as devices for preparing infant milk, generate a beverage by automatically mixing a beverage material and a liquid. In general, such a beverage generating device includes a stirring container, a stirring element that is rotatably disposed in the stirring container, and a stirring motor that rotates the stirring element. The beverage generating device generates a beverage by mixing and stirring a powder material and water or hot water, which are supplied into the stirring container, by using the rotating stirring element.

Regarding such a beverage generating device, for hygienic reasons, it is necessary to periodically clean the stirring container, in which beverage is generated, and the stirring element. Therefore, in general, a stirring element is removable from a stirring container.

PTL 1 discloses a milk foamer including a base body, a cup body disposed on the base body, a cup lid disposed on the cup body, and a stirring mechanism for stirring milk in the cup body. The stirring mechanism includes a stirring head and a shaft for supporting the stirring head. The stirring mechanism and the cup lid are integrated as a unit by fixing the shaft to the cup lid. Therefore, when removing the cup lid from the cup body, the stirring mechanism is removed together. A magnetic drive mechanism for magnetically driving the stirring head is provided in the base body. With this structure, the stirring head can be removed together with the cup lid and can be cleaned. Because the magnetic drive mechanism is provided in the base body, the structure of the cup lid can be simplified, and contamination and corrosion of the drive mechanism and electrical contact portions are reduced.

PTL 2 discloses a liquid ejection device having a stirring mechanism that does not include a shaft. In the liquid ejection device, a bar-shaped stirring element is placed in a container having a discharge hole in the bottom surface, and the stirring element is rotated by an electromagnet that is disposed outside the container and below the container.

PTL 3 discloses a disc-shaped stirring element.

### CITATION LIST

### Patent Literature

PTL 1: International Publication No. 2014/136833 (published on Sep. 12, 2014)
PTL 2: Japanese Unexamined Patent Application Publication No. 2014-184604 (published on Oct. 2, 2014)
PTL 3: Japanese Unexamined Patent Application Publication No. 2011-031199 (published on Feb. 17, 2011)

### SUMMARY OF INVENTION

### Technical Problem

In the stirring mechanism of the milk foamer disclosed in PTL 1, the shaft is rotatably supported by the cup lid, and the stirring head is fixed to the shaft. Therefore, it is not easy to remove the shaft from the cup lid and to perform cleaning and to remove the stirring head from the shaft and to perform cleaning. In particular, when preparing powdered milk and feeding a newborn infant, it is necessary to frequently feed the infant and to periodically clean the stirring mechanism. Therefore, it is preferable that the number of complicated operations be reduced to a minimum. Therefore, it is necessary to reduce the number of elements of the stirring mechanism to a minimum so that the stirring mechanism can be easily cleaned. That is, it is necessary to make the stirring mechanism be easily removable.

With the stirring mechanism of the milk foamer, when stirring milk, because the shaft is located at the center of rotation of the milk, the rotating shaft pulls air into the milk, and thereby it is likely that the milk contains a large amount of bubbles of air and the like. If the milk contains bubbles and the like, air is likely to enter the stomach of an infant, and the infant is likely to burp loudly and may vomit when burping. If the amount of air discharged by burping is insufficient, the infant may cry at night. Therefore, in preparation of infant milk, it is important to suppress bubbling.

In the liquid ejection device disclosed in PTL 2, the discharge hole is necessary to stabilize the center of rotation of the stirring element. Moreover, because the liquid is stirred by rotation of the stirring element having a bar-like shape, a capsule-like shape, or the like, the flow velocity of the liquid while being stirred is high near the center of rotation of the stirring element. As a result, a vortex is generated in the liquid surface, and the vortex causes a problem in that air is taken into the central portion of the vortex and thereby bubbles are generated in the liquid.

The stirring element used in the liquid ejection device has a bar-like shape and stirs the liquid because side portions of the rotating bar apply acting forces to the liquid so as to directly push the liquid. With such a stirring element, because drag against the flow of the liquid necessarily becomes large at portions of the stirring element that apply the acting forces to the liquid, a turbulent flow is generated as the stirring element rotates. If the turbulent flow affects the liquid surface, as with the aforementioned vortex, the turbulent flow causes a problem in that air is taken into the liquid due to the turbulent flow and thereby bubbles are generated in the liquid. Moreover, both ends of the stirring element are sharp, and a turbulent flow tends to be generated at the both ends, that is, at a side surface of an imaginary disc that is formed as the stirring element rotates. Accordingly, when such a stirring element rotates in a liquid, it is likely that bubbles are generated in the liquid.

Moreover, because the stirring element of PTL 2 does not have a shaft, rotation of the stirring element due to the electromagnet may become instable and the axis of rotation of the stirring element may become displaced. That is, if synchronism between the change of the magnetic field of the electromagnet and the rotation of the stirring element is lost and the center of rotation becomes displaced, the stirring element may move violently in the container. Such a movement of the rotation center of the rotating stirring element causes generation of bubbles in the liquid.

In the stirring element disclosed in PTL 3, in order to improve stirring ability, protruding portions are formed on the upper surface of a disc-shaped base body or recessed portions are formed in the side surface of the disc-shaped base body. When such a stirring element is rotated in a liquid, as with the liquid ejection device disclosed in PTL 2, a vortex may be generated in the liquid surface at the position of the center of rotation, or a turbulent flow may be generated due to the protruding portions on the upper surface or in the recessed portions in the side surface, and the vortex or the turbulent flow causes a problem in that bubbles are easily generated in the liquid.

An object of the present invention, which has been devised to solve the existing problems described above, is to provide a stirring element that can suppress generation of bubbles in a liquid.

### Solution to Problem

To solve the problem described above, a stirring element according to an aspect of the present invention is a stirring element that is shaped like a disc and that is to be placed on a bottom portion of a stirring container for stirring a liquid. The stirring element is configured to perform rotational motion about a rotation center that is a center of the disc due to a magnetically acting force from outside. The stirring element includes at least one projecting portion at a position on a lower surface of the stirring element separated from the rotation center, the lower surface facing the bottom portion of the stirring container and the projecting portion projecting toward the bottom portion of the stirring container. An upper surface of the stirring element, which is opposite to the lower surface, is planar.

### Advantageous Effects of Invention

An aspect of the present invention has an advantageous effect that generation of bubbles in a liquid can be reduced.

### BRIEF DESCRIPTION OF DRAWINGS

FIG. 1(a) is a top view of a stirring element of a stirring unit according to a first embodiment of the present invention, and FIG. 1(b) is a sectional view of the stirring unit.

FIG. 2 is an external perspective view of a milk preparation device that is a beverage generating device including the stirring unit.

FIG. 3 is a sectional view illustrating the structure of the milk preparation device.

FIG. 4(a) is a top view of a stirring element of a stirring unit according to a second embodiment of the present invention, and FIG. 4(b) is a sectional view of the stirring unit.

FIG. 5(a) is a top view of a stirring element of a stirring unit according to a third embodiment of the present invention, and FIG. 5(b) is a sectional view of the stirring unit.

FIG. 6(a) is a top view of a stirring element of a stirring unit according to a fourth embodiment of the present invention, and FIG. 6(b) is a sectional view of the stirring unit.

FIG. 7 is a sectional view illustrating the structure of a milk preparation device that is a beverage generating device according to a fifth embodiment of the present invention.

FIG. 8(a) is a top view of a stirring element of a stirring mechanism according to a sixth embodiment of the present invention, and FIG. 8(b) is a sectional view of the stirring mechanism.

FIG. 9 is a top view of a rotary induction plate of the stirring mechanism.

FIG. 10 illustrates an example of a state in which the stirring element is rotating, FIG. 10(a) is related to the stirring mechanism, and FIG. 10(b) is related to a stirring mechanism according to a comparative example.

FIG. 11(a) is a top view of a stirring element of a stirring mechanism according to a seventh embodiment of the present invention, and FIG. 11(b) is a sectional view of the stirring mechanism.

FIG. 12(a) is a sectional view of a stirring mechanism according to an eighth embodiment of the present invention, FIG. 12(b) is a top view of a rotary induction plate of the stirring mechanism, and FIG. 12(c) is a top view of a rotary induction plate of the stirring mechanism according to the sixth embodiment of the present invention.

FIG. 13(a) is a top view of a stirring element of a stirring mechanism according to a ninth embodiment of the present invention, and FIG. 13(b) is a sectional view of the stirring mechanism.

FIG. 14(a) is a top view of a rotary induction plate of the stirring mechanism, and FIG. 14(b) is a top view of a rotary induction plate according to a comparative example.

FIG. 15(a) is a top view of a stirring element of a stirring mechanism according to a tenth embodiment of the present invention, and FIG. 15(b) is a sectional view of the stirring mechanism.

### DESCRIPTION OF EMBODIMENTS

Hereinafter, embodiments of the present invention will be described in detail. For convenience of description, members of the embodiments having the same functions will be denoted by the same numerals and descriptions of such members will be omitted.

### First Embodiment

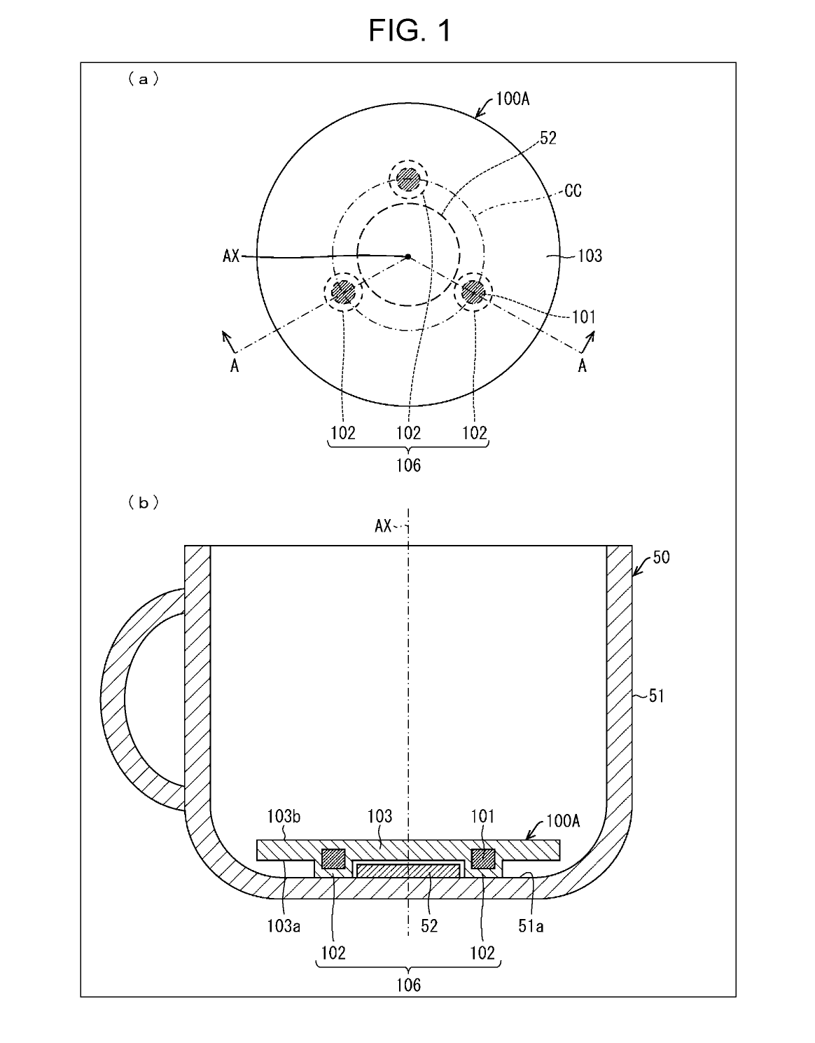

Referring to FIGS. 1 to 3, a first embodiment of the present invention will be described.

A stirring unit described in the present embodiment is included in, for example, a milk preparation device that generates milk by automatically mixing powdered infant milk, which is a beverage material (material), and a heated liquid. Note that a stirring unit according to the present invention is not limited to a stirring unit of a milk preparation device described in the present embodiment. A stirring unit according to the present invention can be appropriately used to perform stirring while suppressing bubbling and ruffling, such as stirring performed in chemical synthesis and an industrial stirring process.

(Structure of Milk Preparation Apparatus 1A)

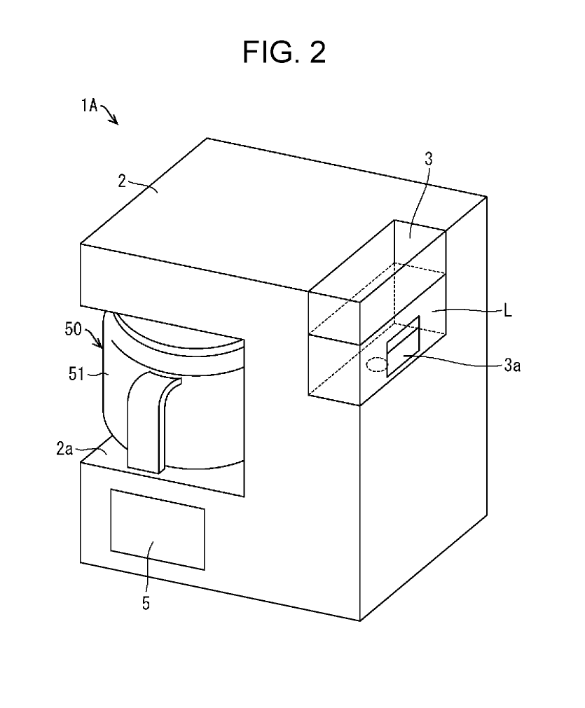

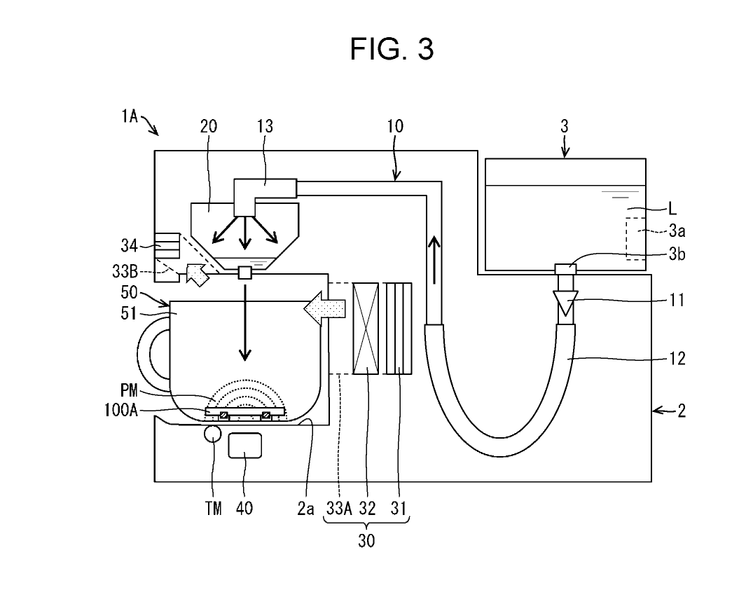

First, referring to FIGS. 2 and 3, the structure of a milk preparation device (beverage generating device, stirring device, milk preparation system) 1A including a stirring unit 50 according to the present embodiment will be described. FIG. 2 is an external perspective view of the milk preparation device 1A that is a beverage generating device including the stirring unit 50 according to the first embodiment. FIG. 3 is a sectional view illustrating the structure of the milk preparation device 1A including the stirring unit 50.

As illustrated in FIGS. 2 and 3, the milk preparation device 1A includes a milk preparation device body 2, which is a housing (base body); a storage container 3 that stores a liquid L; the stirring unit 50; and a stirring motor 40 (rotary drive unit). The milk preparation device 1A further includes a supply pipe 10, a funnel 20, a cooling portion 30, the stirring motor 40, and a thermistor TM, which are disposed in the milk preparation device body 2.

The storage container 3 is a tank that stores the liquid L to be supplied to the stirring unit 50. The storage container 3 is disposed in an upper part of the milk preparation device body 2 and is removable from the milk preparation device body 2. The storage container 3 has a container handle 3a, for removing/attaching or carrying the storage container 3, located on an outer side of the milk preparation device body 2. A supply valve 3b is disposed in a lower part of the storage container 3. The supply valve 3b is closed when the storage container 3 is removed from the milk preparation device body 2. As a result, the storage container 3 can be removed from the milk preparation device body 2, filled with tap water, and then carried. Preferably, the storage container 3 is transparent so that a user can easily check the inside. Preferably, for hygienic reasons, the storage container 3 has a lid (not shown) that can cover an upper opening of the storage container 3. As a liquid stored in the storage container 3, water that is suitable for preparing a baby drink, such as tap water, baby drink water, pure water, or natural water is used.

The milk preparation device body 2 has a setting surface 2a (placement surface), for setting (placing) the stirring unit 50 thereon, at substantially the center. The milk preparation device body 2 has a hollow portion defined by the setting surface 2a, a side portion that covers a side of the stirring unit 50 placed on the setting surface 2a, and an upper portion that covers the top of the stirring unit 50 placed on the setting surface 2a. In the stirring unit 50 loaded by being set on the setting surface 2a, an operation of preparing milk, such as mixing of powdered milk PM with hot water made by heating the liquid L, is performed.

In a part of the milk preparation device body 2 below the stirring unit 50, a control panel 5, which is used by a user to operate the milk preparation device 1A, is disposed.

As illustrated in FIG. 3, the milk preparation device body 2 accommodates the supply pipe 10 for supplying the liquid L stored in the storage container 3, the funnel 20 that is disposed near the outlet of the supply pipe 10 and that functions to adjust the temperature of the liquid L heated and boiled by a heater 12 described below, the stirring unit 50 that is a beverage preparing portion that prepares milk by mixing the heated liquid L and powdered milk PM, the cooling portion 30 that cools the stirring unit 50, the stirring motor 40 for rotating a stirring element 100A in the stirring unit 50, and a thermistor TM that measures the temperature of milk in the stirring unit 50.

The supply pipe 10 is a channel through which the liquid L stored in the storage container 3 flows. One end of the supply pipe 10 is connected to the supply valve 3b of the storage container 3, and the other end is disposed above the funnel 20. The supply pipe 10 includes a float check valve 11 for preventing backflow of the liquid L to the storage container 3; the heater 12 that is a heat supplier for heating, boiling, and sterilizing the supplied liquid L; and a sprinkler nozzle 13 for ejecting and sprinkling the heated liquid L into the funnel 20. To be specific, the float check valve 11 is disposed near one end of the supply pipe 10. The heater 12 is disposed so as to cover a part of the supply pipe 10 extending from a position near the float check valve 11 to a middle position along the channel. The sprinkler nozzle 13 is disposed at the other end of the supply pipe 10 above the funnel 20.

Therefore, when the liquid L stored in the storage container 3 flows from the storage container 3 into the supply pipe 10 through one end of the supply pipe 10, the liquid L passes through the float check valve 11 and flows into the inlet of the heater 12, and flows out of the outlet of the heater 12 to the sprinkler nozzle 13. Then, the liquid L is sprinkled from the sprinkler nozzle 13 to the funnel 20.

As the material of the supply pipe 10, for example, a metal pipe such as a SUS pipe, or a resin pipe, such as a silicone pipe or a Teflon (registered trademark) based pipe, can be used. Preferably, a pipe suitable for supplying foods, such as a silicone-based member, is selected. In the present embodiment, for example, a silicone tube having an inside diameter of ϕ10 mm is used as the supply pipe 10. The material and the inside diameter of the tube may be appropriately set. Connection with various parts may be performed by selectively using any fixing method that is appropriate for the size of the tube and the like.

The float check valve 11 has a function of preventing backflow of the liquid L from the heater 12 to the storage container 3 and a function of stopping supply of the liquid L at the liquid level of the float check valve 11. To be specific, the float check valve 11 includes a small-diameter pipe portion having a small inside diameter, a large-diameter pipe portion that is located below the small-diameter portion and that has a large inside diameter, and a float that is disposed in the large-diameter pipe portion and that has an inside diameter larger than that of the small-diameter pipe portion.

When the liquid L flows into the float check valve 11 from the storage container 3, the float moves downward due to the flow of the liquid L. When the float check valve 11 is filled with the liquid L to the liquid level thereof, the float moves upward and closes the small-diameter pipe portion, and thereby backflow of the liquid L from the supply pipe 10 to the storage container 3 is prevented.

As illustrated in FIG. 3, in the present embodiment, the heater 12 has, for example, a tubular U-shape, and is formed so as to surround and cover a part of the supply pipe 10. For example, a nichrome wire is disposed in the heater 12. The heater 12 has a function of heating, boiling, and sterilizing the liquid L for generating milk and supplying the liquid L to the sprinkler nozzle 13. To be specific, the function is as follows.

(1) From the storage container 3, the liquid L flows through the float check valve 11 into a part of the supply pipe 10 covered by the U-shaped heater 12.
(2) The part of the supply pipe 10 covered by the U-shaped heater 12 is filled with the liquid L to a height at which the float check valve 11 is attached.
(3) The heater 12 starts heating the liquid L, the liquid L boils and is pushed up from the heater 12 due to the vapor pressure.
(4) Because the float check valve 11 is present near the inlet of the heater 12, the liquid L is pushed out from only the outlet of the heater 12 on the opposite side, and the liquid L is supplied to the sprinkler nozzle 13 via the supply pipe 10.
(5) As the liquid L in the part of the supply pipe 10 covered by the heater 12 decreases, the pressure of the inside of the part of the supply pipe 10 covered by the heater 12 decreases, and the float check valve 11 opens. As a result, the process returns to (1) and unheated liquid L flows into the supply pipe 10.

The heater 12 according to the present embodiment includes a temperature sensor (not shown) so that the heating temperature of the heater 12 can be constantly measured.

The process (1) to (5) is repeated until the liquid L is depleted from the storage container 3, and the liquid L that has been heated by the heater 12 is successively fed to the funnel 20. When the liquid L in the supply pipe 10 is depleted, heat from the heater 12 is not easily transferred to the outside, and the temperature of the heater 12 easily increases to a level above the boiling temperature of the liquid L. As a result, by setting and detecting the upper limit temperature, heating of the heater 12 can be stopped.

The sprinkler nozzle 13 has a function of sprinkling and ejecting the liquid L that has been heated and fed to the sprinkler nozzle 13. A plurality of small holes or thin slits are formed in a lower wall at the tip of the sprinkler nozzle 13. By changing the size of the holes or slits, it is possible to sprinkle and eject the liquid L like a shower or like mist of smaller droplets. Because the surface area of the liquid L increases when the liquid L is divided into small droplets, heat exchange between the liquid L and air in the space in the funnel 20 is accelerated. As a result, the temperature of the liquid L decreases.

The funnel 20 is disposed above the stirring unit 50 set on the setting surface 2a. The funnel 20 collects the liquid L that has been sprinkled by the sprinkler nozzle 13 and whose temperature has decreased, and drips the liquid L from a lower outlet to the stirring unit 50 disposed below the funnel 20. Accordingly, the sprinkler nozzle 13 and the funnel 20 function as first temperature adjusting means that cools the liquid L that has been heated and boiled by the heater 12.

The stirring unit 50 generates milk by adjusting and mixing powdered infant formula, that is, powdered milk PM that has been set therein and the liquid L for generating milk, which has been boiled. When the stirring unit 50 is placed on the setting surface 2a, the stirring unit 50 is located below the funnel 20. The stirring unit 50 includes a stirring container 51 and the stirring element 100A (described below) for stirring and mixing the powdered milk PM and the liquid L. The stirring element 100A is placed on the bottom surface of the stirring container 51. Magnets 101 (see FIG. 1) are disposed in the stirring element 100A. The magnets 101 form pairs with magnets (not shown) disposed on the rotation shaft of the stirring motor 40, which is disposed in the milk preparation device body 2 below the stirring unit 50. The stirring element 100A rotates as the stirring motor 40 rotates. The details of the structure of the stirring unit 50 will be described below with reference to FIG. 1.

In the present embodiment, the stirring motor 40 can continue operating at least for a time that is sufficient for dissolving the powdered milk PM in the liquid L. The stirring motor 40 includes magnets that form pairs with the magnets 101 (see FIG. 1) of the stirring element 100A. The stirring motor 40 rotates the stirring element 100A, which is separated from the stirring motor 40, by rotating the magnets or by driving the magnets so as to repeatedly switch the south pole and the north pole.

As illustrated in FIG. 3, the cooling portion 30 includes a fan 32 for moving air, an air inlet 31, ducts 33A and 33B, and an air outlet 34. The cooling portion 30 functions as second temperature adjusting means for cooling the liquid L and milk after being mixed. The outlet of the duct 33A is disposed in a side portion of the hollow portion of the milk preparation device body 2 so as to be located on a side of the stirring unit 50 set on the setting surface 2a. The air inlet 31 and the fan 32 are disposed at the inlet of the duct 33A.

The inlet of the duct 33B is located in an upper part of the hollow portion of the milk preparation device body 2 so as to be located above the stirring unit 50 set on the setting surface 2a. The air outlet 34 is disposed at the outlet of the duct 33B.

The fan 32 has a function of moving air for cooling milk in the stirring unit 50 to a target temperature. As illustrated in FIG. 3, the fan 32 is disposed in the milk preparation device body 2 and has the air inlet 31 for sucking air to a position upstream of the fan 32. The outlet of the duct 33A is disposed downstream of the fan 32. The duct 33A is disposed in a height range including the height of the edge of the stirring container 51 of the stirring unit 50 set on the setting surface 2a.

The hollow portion of the milk preparation device body 2 is formed between the inlet of the duct 33B and the outlet of the duct 33A, and the stirring unit 50 is disposed in the hollow portion.

The duct 33A is formed by forming an opening in a part of the milk preparation device body 2 so that air can be blown against the stirring container 51 of the stirring unit 50 from a side or from below.

As the fan 32 rotates, air that has been taken in from the air inlet 31 passes through the fan 32 and the outlet of the duct 33A and is blown sideways against a side surface of the stirring container 51, in particular, an edge portion of the stirring container 51. Then, the air that has been blown against the side surface of the stirring container 51, in particular, the edge portion of the stirring container 51, flows from the inlet of the duct 33B into the duct 33B, passes from the inside of the milk preparation device body 2 through the air outlet 34, and is discharged to the outside of the milk preparation device body 2. With such a structure, airflow is generated in an upper part of the hollow portion above the stirring unit 50 set on the setting surface 2a, and heat is transferred from the inside of the stirring unit 50 and can be easily dissipated to the outside. As a result, heat dissipation from milk due to convection is accelerated. In contrast, when the fan 32 is stopped to stop moving air toward the stirring unit 50, heat is accumulated in the space in the stirring unit 50, and the heat cannot be easily dissipated from the milk.

It may be possible to cool milk rapidly by directly blowing air against the milk in the stirring unit 50. However, when air is directly blown against the milk, it becomes more likely that foreign substances, such as dust, enter the milk. When contacting the liquid L, dust and the like are trapped in the liquid L due to surface tension. Therefore, this method is very inappropriate for preparing a beverage for a baby.

Therefore, the present embodiment has the aforementioned structure so that air is not directly blown against the milk. To be specific, in the milk preparation device 1A, the air inlet 31 for moving air toward the stirring unit 50, the fan 32, and the duct 33A are disposed on a side of the stirring unit 50 placed on the setting surface 2a; and the duct 33B and the air outlet 34, for discharging air moved to the stirring unit 50 from the inside to the outside of the milk preparation device body 2, are disposed above the stirring unit 50 placed on the setting surface 2a. Thus, the milk preparation device 1A realizes cooling of milk by dissipation of heat using two airflows, including dissipation of heat from the stirring unit 50 and dissipation of heat from a heat accumulation region in an upper part of the stirring unit 50 that is formed as heat of milk in the stirring unit 50 moves upward.

The thermistor TM is used to indirectly measure the temperature of the liquid L or milk in the stirring unit 50. By measuring the relationship between the temperature of milk in the stirring unit 50 and the temperature measured by the thermistor TM beforehand, it is possible for a user to set the temperature of milk to be prepared. Thus, the milk preparation device 1A determines whether preparation of milk has been finished from the temperature detected by the thermistor TM and informs a user that preparation of milk has been finished by using a sound or an indicator lamp.

In the present embodiment, the temperature of the liquid L or milk in the stirring unit 50 is checked from the temperature of the outer surface of the stirring unit 50. Therefore, preferably, the milk preparation device 1A includes a plate spring, for causing the thermistor TM to contact the stirring unit 50 so that heat can be reliably transferred from the stirring unit 50 to the thermistor TM, and a positioning pin or a guide, for maintaining the positional relationship between the stirring unit 50 and the milk preparation device body 2.

The prepared milk is transferred to a baby bottle and fed to a baby. Therefore, when informing a user that preparation of milk has been finished by using a sound or an indicator lamp, preferably, a temperature higher than a target temperature of 40° C., which may be roughly about 45° C., is set beforehand.

With the milk preparation device 1A, which is an automatic milk preparation device, it is possible to automatically prepare milk and to cool the milk rapidly by measuring a liquid L and powdered milk PM that are necessary for preparing a desired amount of milk respectively in the storage container 3 and the stirring unit 50 and by activating the milk preparation device 1A. Using an existing stirring mechanism in the stirring unit 50 causes a problem in that prepared milk contains a large amount of bubbles. That is, for example, when an existing bar-shaped stirring element or the like is used, a large vortex flow or swell occurs in the milk as the stirring element rotates, air is pulled into the milk from the center of the vortex, and the amount of bubbles contained in the milk increases. With the milk foamer disclosed in PTL 1, in which the stirring head is supported by a shaft, the shaft pulls into the milk and the amount of bubbles contained in the milk increases.

In contrast, the stirring element 100A according to the present embodiment has only a small number of projections that generate resistance when rotated, is disc-shaped, and has a flat front surface as described below. Therefore, bubbles are not likely to be generated when the stirring element 100A rotates. The stirring element 100A includes the magnets 101 and is rotated by magnetism from the stirring motor 40, which is disposed separate from the stirring element 100A. Therefore, in contrast to the milk foamer disclosed in PTL 1, because the stirring element 100A need not have a shaft for rotating the stirring element 100A, bubbles are not generated in milk due to rotation of the shaft. Also for this reason, it is possible to reduce the amount of bubbles contained in the milk. Moreover, the stirring element 100A can be easily removed from the stirring unit 50 and can be cleaned easily. Furthermore, the stirring element 100A according to the present embodiment has high rotation stability.

As a result, by using the milk preparation device 1A, which includes the stirring unit 50 including the stirring element 100A according to the present embodiment, it is possible to automatically generate milk, prepare a feed, and cool the feed to a desired temperature in compliance with “Safe preparation, storage and handling of powdered infant formula: guidelines”.

Here, the reason why the reason stirring element according to the present invention can effectively suppress generation of bubbles will be described below in detail. When a general stirring element rotates, bubbles are generated due to the following two phenomena:

(1) a phenomenon in that, because a rotational flow near the rotation center of the stirring element is large, a vortex is generated in the liquid surface and air is taken into the liquid due to the vortex; and
(2) a phenomenon in that a turbulent flow is generated at portions of the stirring element that apply an acting force to the liquid as the stirring element rotates, and air is taken into the liquid in the same way because the turbulent flow affects the liquid surface.

Accordingly, it is necessary to reduce occurrence of the above phenomena in order to suppress generation of bubbles. However, with a general stirring element, when the rotation speed of the stirring element is sufficiently increased in order to improve the stirring ability, a rotational flow intensifies near the rotation center of the stirring element, and a vortex tends to be generated. In order to increase stirring efficiency, it is preferable that the stirring element includes a member, such as a projecting portion or the like, that applies an acting force as the stirring element rotates. However, such a member tends to generate a turbulent flow. Therefore, with a general stirring element, it is very difficult to reduce occurrence of the aforementioned phenomena.

In contrast, in order to solve the above problem, a stirring element according to the present invention has a disc-like shape and the upper surface of the stirring element has a streamlined shape with respect to rotational motion. Here, the term “streamlined shape” refers to a shape that does not generate or does not easily generate a vortex or a turbulent flow with respect to relative flow of a fluid, that does not change its streamline in a steady laminar flow from one direction, and that generates only a small drag against a liquid. This means that the cross-sectional area of the stirring element changes by only slightly with respect to the direction of a flow, and that main structures, such as a projecting portion that generates drag against the liquid to increase the ability of stirring the fluid, are not present on the upper surface of the stirring element. Thus, it is possible to suppress generation of a vortex or a turbulent flow from the upper surface of the stirring element due to the rotational motion of the stirring element.

Moreover, the stirring element according to the present invention includes, on the lower surface of the stirring element that faces the bottom portion of the stirring container, a contact portion that contacts the bottom portion of the stirring container and a non-contact portion separated from the bottom portion of the stirring container; and the stirring element rotates in a state in which the non-contact portion is spaced apart from the bottom surface of the stirring container. With such a structure, it is possible to effectively utilize a rotational flow that is generated between the bottom surface of the stirring container and the stirring element.

As a preferred embodiment of the present invention, main structures, such as a projecting portion that generates drag against the liquid in order to increase the ability of stirring a liquid, are disposed on the lower surface of the stirring element. That is, preferably, the lower surface of the stirring element has an unstreamlined shape. With such an embodiment, even if a turbulent flow is formed on the lower surface of the stirring element, the turbulent flow does not affect the liquid surface, because the turbulent flow is shielded by the body portion of the stirring element having a disc-like shape.

On the other hand, a part of a rotational flow generated on the lower surface of the stirring element leaks through a gap between a side wall of the disc-shaped stirring element and a side wall of the stirring container to the liquid on the upper side of the stirring element and indirectly rotates the liquid on the upper side of the stirring element, thereby stirring the entirety of the liquid. The rotational flow that has leaked through the gap between the side wall of the disc-shaped stirring element and the side wall of the stirring container forms a laminar flow along the side wall of the stirring container and performs a large rotational motion. Therefore, the rotational flow is not likely to take air into the liquid and is not likely to form bubbles. Because the rotation center is distanced from an outer rotational area to which the rotational flow leaks, the speed of the rotational flow at the rotation center is relatively low, and generation of a vortex at the rotational center is suppressed.

Thus, the stirring element according to the present invention can reduce generation of a vortex in the liquid surface, can reduce the effect of a turbulent flow on the liquid surface, and can suppress generation of bubbles.

Examples of the streamlined shape of the upper surface of the stirring element include a planar shape and the shape of a solid of revolution. As long as a vortex and a turbulent flow are not generated, the upper surface of the stirring element may have a protruding portion or a recessed portion.

The flat upper surface need not be completely flat and may have a substantially planar shape when the stirring element is viewed in full scale. Examples of the planar upper surface include, as described below, a totally flat shape, and a shape that bulges from a peripheral portion toward the rotation center. For example, the planar upper surface includes a totally flat shape, a shape that bulges from a peripheral portion toward the rotation center, and a shape that has a flat central portion and a peripheral portion that is inclined downward.

(Structure of Stirring Unit 50)

Referring to FIGS. 1(a) and 1(b), the stirring element 100A will be described.

FIG. 1(a) is a top view of the stirring element 100A according to the present embodiment. FIG. 1(b) is a sectional view of the stirring unit 50 in which the stirring element 100A illustrated in FIG. 1(a) is placed in the stirring container 51. This sectional view is taken along line A-A of FIG. 1(a) and seen in the direction of arrows. Hereinafter, a state in which the stirring element 100A is placed in the stirring container 51 and a stirring operation will be described.

The stirring unit 50 includes the stirring container 51 and the stirring element 100A. The stirring container 51 includes a protruding portion 52 (container-side protruding portion) that is located at substantially the center of a bottom surface 51a (bottom portion) and protrudes from the bottom surface 51a. The protruding portion 52 functions as an axis when the stirring element 100A rotates about a rotation axis AX. The protruding portion 52 is integrally formed with the stirring container 51. In the present embodiment, the protruding portion 52 has a solid-cylindrical shape. That is, the protruding portion 52 is circular in plan view when the stirring container 51 is seen from above to below (from above to below the plane of FIG. 1(b)). The stirring element 100A includes a disc-shaped plate portion 103, the plurality of magnets 101, and a plurality of projecting portions 102 (contact portion, first projecting portion, dot-shaped projecting portion). The stirring element 100A has a circular shape in plan view.

The plate portion 103 has a disc-like shape. An adaptation portion 106 is disposed on a back surface 103a (lower surface) of the plate portion 103, which faces the bottom surface 51a of the stirring container 51. The adaptation portion 106 is disposed concentrically (on a concentric circle) with respect to the rotation center of the stirring element 100A and projects from the back surface 103a. Preferably, the plate portion 103 and the adaptation portion 106 are each made of a resin that is suitable for food equipment. For example, silicone, Teflon (registered trademark) based resin, polypropylene, or the like, which is the same as the material of the supply pipe 10, is preferably used. A front surface 103b (upper surface) of the plate portion 103, which is opposite to the back surface 103a, is a planar surface that does not have a projection.

The adaptation portion 106 includes the plurality of projecting portions 102 that support the rotating stirring element 100A at three or more multiple points in such a way that the stirring element 100A is in contact with the protruding portion 52. In the present embodiment, the number of the projecting portions 102 is three, and the projecting portions 102 are disposed so as to be point-symmetric about the rotation axis AX of the stirring element 100A. The adaptation portion 106 need not include the plurality of projecting portions 102 and may have an annular shape that is concentric with the rotation axis AX. That is, the adaptation portion 106 may have any appropriate shape that is adapted to the protruding portion 52. Tips of the projecting portions 102 are in contact with the bottom surface 51a of the stirring container 51.

The protruding portion 52 is covered by the plurality of projecting portions 102 of the stirring element 100A and a region of the back surface 103a of the plate portion 103 of the stirring element 100A, the region being surrounded by the plurality of projecting portions 102. Note that, when the surface of the protruding portion 52 is in contact with the region of the back surface 103a of the plate portion 103, which is surrounded by the projecting portions 102, the tips of the projecting portions 102 need not be in contact with the bottom surface 51a of the stirring container 51.

The plurality of magnets 101 are disposed in the stirring element 100A. Each of the magnets 101 is inserted into a corresponding one of the projecting portions 102. The surface of the magnet 101 is covered with a resin (not shown). Thus, the magnet 101 is not exposed. Preferably, the surface of the magnet 101 is made of a resin that is suitable for food equipment. For example, silicone, Teflon (registered trademark) based resin, polypropylene, or the like, which is the same as the material of the supply pipe 10 in the milk preparation device body 2, is preferably used. The resin, which covers the surface of the magnet 101, may be integrally formed with the plate portion 103 and the projecting portion 102.

When the stirring element 100A is rotating about the rotation axis AX, side surfaces of the projecting portions 102 contact the side surface (outer periphery) of the protruding portion 52, and thereby the projecting portions 102 support the stirring element 100A on the protruding portion 52. The shape of each of the projecting portions 102 is, for example, a cylindrical shape but is not limited to this shape. The shape of each of the projecting portions 102 may be any appropriate shape that generates only a low friction with the side surface of the protruding portion 52 when the stirring element 100A rotates. A support-portion rotation circle CC is defined as a circle that is the locus of the centers of the projecting portions 102 that rotate about the rotation axis AX of the stirring element 100A. In other words, the plurality of projecting portions 102 are disposed concentrically around the rotation axis AX of the stirring element 100A.

The stirring element 100A is disposed so as to cover the protruding portion 52, which is disposed on the bottom surface 51a of the stirring container 51 and which has a solid-cylindrical shape. That is, the stirring element 100A is rotatably mounted on the protruding portion 52 of the stirring container 51. Thus, when the stirring element 100A is mounted on the protruding portion 52, the protruding portion 52 is surrounded by three or more projecting portions 102 and is disposed concentrically with the rotation axis AX to a degree such that the three projecting portions 102 are separated from the outer periphery of the protruding portion 52. Therefore, it is possible to easily set the stirring element 100A at a predetermined position on the bottom surface 51a of the stirring container 51. That is, it is possible to easily set the stirring element 100A so as to cover the protruding portion 52. Therefore, a user can set the stirring element 100A with a simple operation, and complicated operations can be reduced when setting the stirring element 100A in the stirring container 51.

The magnets 101 are disposed in the projecting portions 102 of the stirring element 100. Therefore, the weight of the stirring element 100A is increased due to the weight of the magnets 101, and the magnets 101 are magnetically coupled to the magnets disposed in the stirring motor 40. As a result, the stability of rotation of the stirring element 100A is improved. That is, because the magnets 101 in the projecting portions 102 and the magnets supported by the stirring motor 40 attract each other, the stirring element 100A can be stably mounted on the protruding portion 52. Even if synchronism between the rotation of the stirring element 100A and the rotation of the stirring motor 40 is lost while the stirring element 100A is rotating, the stirring element 100A does not move violently in the stirring container 51, and the magnets 101 in the projecting portions 102 of the stirring element 100A and the stirring motor 40 can become magnetically coupled again.

Therefore, the stirring element 100A can keep stability during a stirring operation and against a vertical displacement when hot water or the like is poured from above. As a result, the stirring element 100A can rotate at a high speed and can be prevented from accidentally detached. With this structure, it is possible to remove a shaft, which has been necessary to keep stability. Therefore, the stirring element 100A can have a structure having only a small number of elements.

Thus, the stirring element 100A can stably rotate without a shaft-like support as in the milk foamer described in PTL 1, and an operation of attaching a shaft can be reduced. That is, the stirring element 100A can be easily removed and easily cleaned.

If the diameter of the protruding portion 52 is too small, that is, if the clearance between the protruding portion 52 and the projecting portions 102 is too large, the stirring element 100A may become detached from the protruding portion 52 as the stirring element 100A rotates. Therefore, preferably, the projecting portions 102 and the protruding portion 52 are separated from each other to a degree such that the stirring element 100A does not become detached from the protruding portion 52 when the stirring element 100A rotates.

In order to further stabilize the stirring element 100A against displacement, a weight for increasing the weight of the stirring element 100A may be embedded in the stirring element 100A.

The magnets 101 of the stirring element 100A are arranged so as to form pairs with the magnets disposed in the stirring motor 40 and so as to face the magnets via the setting surface 2a, the bottom surface 51a of the stirring container 51, and the like. The magnets 101 are driven by the stirring motor 40, and thereby the stirring element 100A rotates.

When the stirring element 100A is rotating about the rotation axis AX in the stirring container 51, an outer part of the liquid surface rises due to a centrifugal force and a central part of the liquid surface falls. In such a state, the contact area between milk and the inner surface of the stirring container 51 and the surface area of the milk both increase. Therefore, the heat dissipation area of the milk increases, and the milk can be easily cooled. Because the liquid surface changes as described above, it is necessary that the stirring container 51 have a size that can contain milk in an amount larger than the amount of milk to be prepared.

It may be possible to cool milk further rapidly by maximally increasing the rotation speed of the stirring element 100A and maximally increasing the contact area between the inner surface of the stirring container 51 and milk.

However, if the rotation speed is increased, splashing, swelling, and the like of milk tend to occur, and a large amount of bubbles are taken into the milk. When milk containing bubbles is fed to the baby, the amount of air that enters the stomach of a baby increases. As a result, the baby may burp loudly, and, if the baby cannot burp well, the baby may vomit milk when burping. If the baby vomits milk, it becomes necessary to feed milk to the baby again or to feed milk frequently, and feeding of milk becomes very burdensome for a person who feeds milk, such as the mother. Accordingly, a method that may generate milk including a large amount of bubbles is very inappropriate for preparing milk to be fed to a baby.

In particular, when milk in the stirring container collides with an obstacle, such as a side surface of the stirring container, air is taken into the milk, and bubbling of the milk accelerates. Therefore, if a stirring element has a shape that may disturb a flow and may increase swelling or if the stirring container has a structure that may obstruct a rotational flow of milk, the stirring element is more likely to take air into the milk.

In contrast, the stirring element 100A according to the present embodiment has a shape that is line-symmetric about the rotation axis AX and the front surface 103b has a flat shape. That is, because the milk preparation device 1A does not have a shaft and has the stirring element 100A having a flat shape, there are only a small number of factors that may obstruct the flow of milk in the stirring container 51. Therefore, it is less likely that air is taken into milk when preparing the milk. Thus, the milk preparation device 1A can easily cool milk and can reduce the amount of bubbles contained in the milk. Accordingly, with the milk preparation device 1A including the stirring element 100A, it is possible to prepare milk containing only a small amount of bubbles.

(Main Advantages of Milk Preparation Apparatus 1A)

As described above, the milk preparation device 1A includes the stirring unit 50, which includes the stirring element 100A and the stirring container 51; and the milk preparation device body 2, in which the stirring motor 40 for magnetically driving the stirring element 100A is disposed below the setting surface 2a on which the stirring unit 50 is to be set.

The stirring element 100A, having the flat front surface 103b, has a streamlined shape with respect to rotational motion. Thus, it is possible to suppress generation of a vortex or a turbulent flow from the front surface 103b of the stirring element 100A due to the rotational motion of the stirring element 100A.

The stirring element 100A has the projecting portions 102 on the back surface 103a, which are in contact with the bottom surface 51a of the stirring container 51. Thus, it is possible to effectively utilize a rotational flow that is generated between the bottom surface 51a of the stirring container 51 and the stirring element 100A and to suppress the effect of a vortex or a turbulent flow, which is generated due to the rotational flow, on the liquid surface. Accordingly, it is possible to suppress generation of bubbles. Moreover, with the projecting portions 102, it is possible to improve the ability of the stirring element 100A in stirring a liquid when the stirring element 100A rotates (stirring ability). Because the projecting portions 102 are disposed on the back surface 103a, the projecting portions 102 are not likely to pull air into milk. Accordingly, it is possible to suppress increase of generation of bubbles due to the projecting portions 102.

The magnets 101 are disposed in the stirring element 100A. Therefore, the stirring element 100A can rotate about the rotation axis AX as the magnets 101 are magnetically driven by a magnetic force from the stirring motor 40 disposed outside the stirring container 51. Thus, in contrast to the stirring mechanism described in PTL 1, it is not necessary to provide a shaft that is connected to the stirring element and rotates the stirring element. Therefore, it is possible to prevent mixing of bubbles into milk in the stirring container 51 due to rotation of the shaft.

Because the stirring element 100A need not have a shaft for rotating the stirring element, the stirring element 100A can be easily attached to and removed from the stirring container 51 and is highly convenient.

The stirring element 100A, having a circular shape in plan view, does not have a projection on a side surface and smoothly rotates. For example, compared with a bar-shaped stirring element, it is possible to suppress bubbling of milk.

Because the front surface 103b of the stirring element 100A is circular, compared with a bar-shaped stirring element, the contact area between the front surface 103b and the milk is large. The function of the stirring element 100A when mixing the powdered milk PM and the liquid L is substantially equivalent to that of a bar-shaped stirring element.

Moreover, the adaptation portion 106 is disposed on the back surface 103a of the stirring element 100A concentrically with respect to the rotation axis AX of the stirring element 100A so as to surround the outer periphery of the protruding portion 52, which is disposed on the bottom surface 51a of the stirring container 51 and is circular in plan view. Thus, when the stirring element 100A rotates about the rotation axis AX, the adaptation portion 106 and the protruding portion 52 together function structurally as a rotation shaft. Therefore, the stirring element 100A can stably rotate without being displaced from the rotation axis AX. Also in this respect, for example, compared with a bar-shaped stirring element, it is possible to suppress reduction of stirring ability while suppressing generation of bubbles in the milk.

The adaptation portion 106 includes the plurality of projecting portions 102 for supporting the rotating stirring element 100A on the protruding portion 52 at three or more multiple points. To be specific, for example, the adaptation portion 106 includes three projecting portions 102. With the three projecting portions 102, compared with a case where the number of the projecting portions 102 is two or less, it is possible to further improve the stirring ability. Moreover, because the stirring element 100A is supported by the side surface of the protruding portion 52, it is possible to prevent detachment of the stirring element 100A from the protruding portion 52 when the stirring element 100A rotates. Therefore, the stirring element 100A can rotate stably about the rotation axis AX. The number of the projecting portions 102 is not limited to three, and four or more projecting portions 102 may be disposed concentrically around the rotation axis AX. In this case, the stirring element 100A can rotate more stably about the rotation axis AX. Moreover, the adaptation portion 106 need not include the plurality of projecting portions 102 and may have an annular shape that is concentric around the rotation axis AX. Also with such a structure, it is possible to rotate the stirring element 100A more stably about the rotation axis AX.

The projecting portions 102 are disposed point-symmetric about the rotation axis AX. In other words, the distances between any adjacent pairs of the three projecting portions 102 are the same. Thus, when the stirring element 100A rotates, centrifugal forces are generated at the projecting portions 102 symmetrically from the center of the stirring element 100A. Therefore, stability of the rotation of the stirring element 100A is improved.

The adaptation portion 106 may have any appropriate shape and position as long as the adaptation portion 106 can keep the plate portion 103 on the protruding portion 52 when the stirring element 100A is rotating about the rotation axis AX.

In the stirring element 100A, the magnets 101 are disposed in the projecting portions 102. Thus, the magnets 101 are disposed at positions in the stirring element 100A near the outside. Therefore, the magnets 101 can easily receive magnetic forces (magnetically acting forces) from the outside. Moreover, the weight of the stirring element 100A increases due to the weight of the magnets 101, and the magnets 101 are magnetically coupled with the magnets of the stirring motor 40. Thus, it is possible to further rotate the stirring element 100A about the rotation axis AX. That is, the rotating stirring element 100A can be more reliably mounted on the protruding portion 52, and therefore it is possible to suppress generation of bubbles in milk that is being stirred and to more reliably stir the milk.

Moreover, by disposing the magnets 101 in the projecting portions 102, it is possible to dispose the magnets 101 so that lower end portions of the magnets 101 surround the outer periphery of the protruding portion 52. Thus, for example, compared with a case where the magnets 101 are disposed only in the plate portion 103, it is possible to lower the center of gravity of the stirring element 100A and to rotate the stirring element 100A more stably.

When the stirring element 100A is rotating, friction is generated when the protruding portion 52 and the outer peripheries of the projecting portions 102 contact each other. Therefore, preferably, the protruding portion 52 and the projecting portions 102 are made of materials having a low friction coefficient.

Each of the projecting portions 102 may be connected to the plate portion 103 so as to be rotatable about the center of the projecting portion 102. In this case, when the stirring element 100A is rotating about the rotation axis AX and if the side surfaces of the projecting portions 102 and the side surface of the protruding portion 52 contact each other, the projecting portions 102 rotate, and therefore it is possible to suppress friction between the projecting portions 102 and the protruding portion 52. Thus, it is possible to rotate the stirring element 100A more stably about the rotation axis AX.

The distance between adjacent projecting portions 102 is smaller than the diameter of the protruding portion 52. Thus, when the rotation axis AX of the rotating stirring element 100A becomes displaced from the center of the protruding portion 52, the protruding portion 52 cannot pass through a space between the projecting portions 102, and therefore the stirring element 100A is not detached from the protruding portion 52. Accordingly, it is possible to prevent detachment of the stirring element 100A from the protruding portion 52 while the stirring element 100A is rotating.

The projecting portions 102 may contact the bottom surface 51a instead of the protruding portion 52. In this case, friction is generated between the projecting portions 102 and the bottom surface 51a. Regarding the friction, with increasing distance from the rotation axis AX to the projecting portion 102, the rotation amount (movement distance) of the projecting portions 102 increases, and energy loss due to the friction increases. Accordingly, it is preferable that the projecting portions 102 be close to the rotation axis AX.

### Second Embodiment

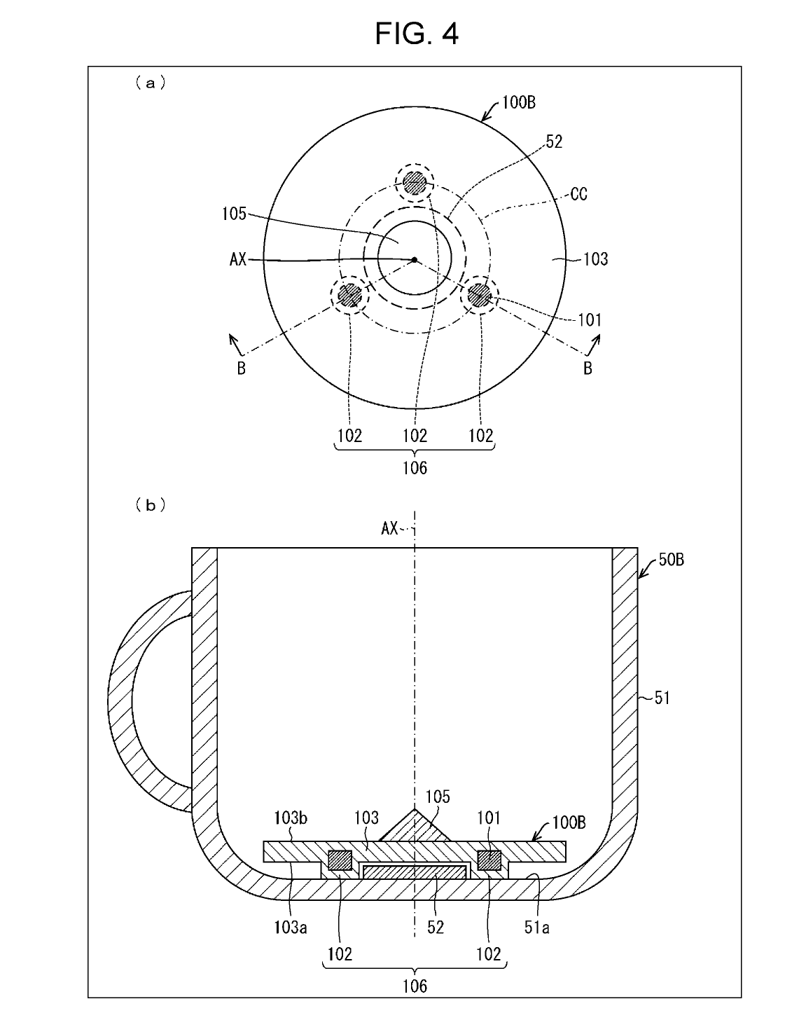

Referring to FIGS. 4(a) and 4(b), a second embodiment of the present invention will be described. Except for the structures described in the present embodiment, the second embodiment is the same as the first embodiment.

FIG. 4(a) is a top view of a stirring element 100B according to the second embodiment of the present invention. FIG. 4(b) is a sectional view of a stirring unit 50B in which the stirring element 100B shown in FIG. 4(a) is placed in the stirring container 51. This sectional view is taken along line B-B of FIG. 4(a) and seen in the direction of arrows.

The milk preparation device 1A (see FIG. 3) may include the stirring unit 50B, instead of the stirring unit 50. Description of the milk preparation device body 2 of the milk preparation device 1A, which is the same as that described in the first embodiment with reference to FIG. 3, will be omitted.

The stirring unit 50B includes the stirring container 51 and the stirring element 100B. In the stirring element 100A (see FIG. 1) disposed in the stirring unit 50 according to the first embodiment, the front surface 103b of the plate portion 103 of the stirring element 100A is a planar surface and does not have a projection.

In contrast, as illustrated in FIG. 4, in the stirring element 100B of the stirring unit 50B according to the present embodiment, a separator 105 (upper-surface projecting portion), which is a projection, is disposed at the rotation center of the front surface 103b of the plate portion 103. In other respects, the stirring element 100B is the same as the stirring element 100A.

The separator 105 is integrally formed with the plate portion 103 on the front surface 103b of the plate portion 103. That is, the separator 105 is fixed to the front surface 103b of the plate portion 103. The separator 105 has a conical shape and is disposed so that the apex is located on the rotation axis AX of the stirring element 100B.

The separator 105 functions to efficiently distribute powdered milk PM in the stirring container 51 when a user places the powdered milk PM into the stirring container 51. That is, when a user places the powdered milk PM onto the stirring element 100B from above the stirring container 51, the separator 105 functions to spread the powdered milk PM radially over the front surface 103b of the stirring element 100B.

Thus, it is possible to suppress generation of a wet lump of powdered milk PM when a heated liquid L is supplied to the stirring unit 50B.

Once a lump of powdered milk PM is generated, it is not easy to dissolve the lump. In particular, if a lump of powdered milk PM is generated while milk is comparatively gently stirred so as not to generate bubbles, the lump is not easily dissolved, and an undissolved part of the powdered milk PM is likely to remain in the milk that has been prepared.

In contrast, by stirring milk by using the stirring element 100B having the separator 105, it is possible to prevent generation of an undissolved part of the powdered milk PM while preventing generation of bubbles in the milk. Therefore, it is possible to efficiently dissolve the powdered milk PM.

The separator 105 may have any appropriate shape. Preferably, the separator 105 has a conical shape so that powdered infant formula can be evenly spread around the separator 105. The shape of the separator 105 may be a pyramid, such as a triangular pyramid or a square pyramid. In this case, when the stirring element 100B rotates, side surfaces of the separator 105 can assist stirring of milk. Because the apex at the tip of the separator 105 is located adjacent to the rotation axis AX and the side surfaces of the separator 105 are inclined from the apex of the separator 105 toward the front surface 103b of the stirring element 100B, a vortex is not likely to be formed in milk when the stirring element 100B rotates the milk. Preferably, the separator 105 has a conical shape because the conical shape is effective in suppressing generation of bubbles when stirring milk.

### Third Embodiment

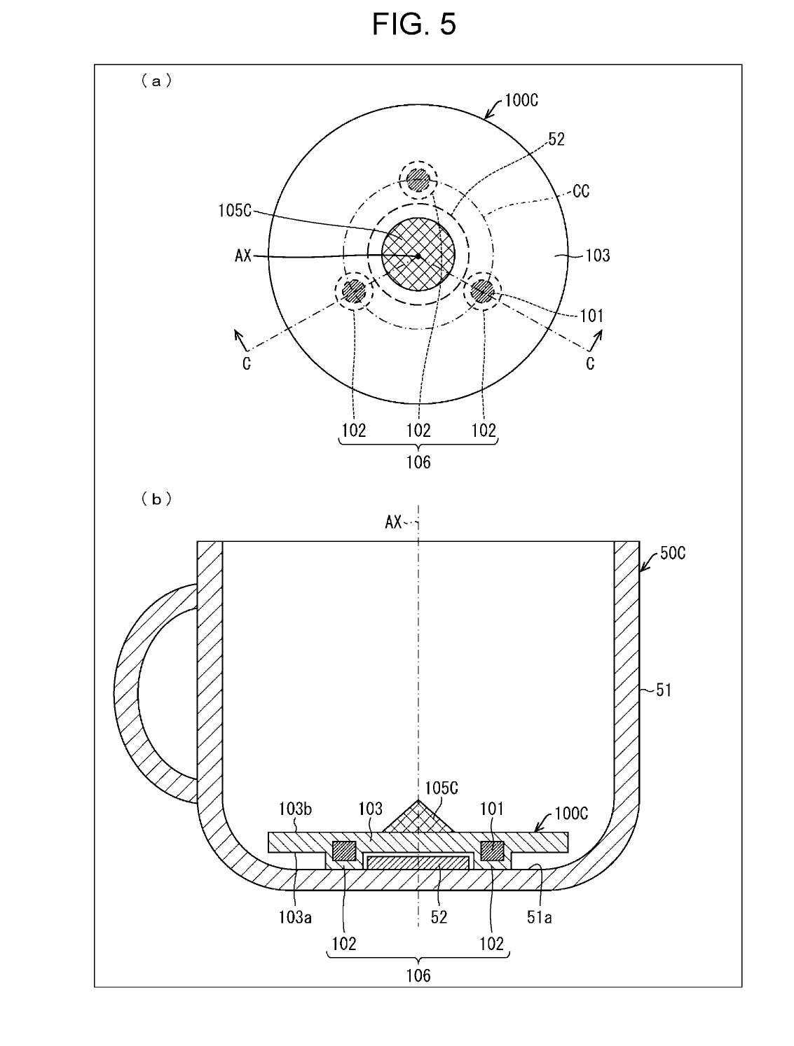

Referring to FIGS. 5(a) and 5(b), a third embodiment of the present invention will be described. Except for the structures described in the present embodiment, the third embodiment is the same as the first and second embodiments.

FIG. 5(a) is a top view of a stirring element 100C according to the third embodiment of the present invention. FIG. 5(b) is a sectional view of a stirring unit 50C in which the stirring element 100C shown in FIG. 5(a) is placed in the stirring container 51. This sectional view is taken along line C-C of FIG. 5(a) and seen in the direction of arrows.

The milk preparation device 1A (see FIG. 3) may include the stirring unit 50C, instead of the stirring unit 50. Description of the milk preparation device body 2 of the milk preparation device 1A, which is the same as that described in the first embodiment with reference to FIG. 3, will be omitted.

The stirring unit 50C includes the stirring container 51 and the stirring element 100C. The stirring element 100C differs from the stirring element 100B in that the stirring element 100C includes a separator 105C, instead of the separator 105 of the stirring element 100B. In other respects, the stirring element 100C is the same as the stirring element 100B.

The separator 105C has a structure in which a plurality of recesses, such as dimples or embosses, are formed in the surface of the separator 105. With the stirring element 100C, the recesses in the surface of the separator 105C can accelerate stirring of the powdered milk PM. Therefore, in addition to the advantages of the stirring element 100B including the separator 105, the amount of undissolved powdered milk PM is further reduced and milk can be efficiently prepared.

### Fourth Embodiment

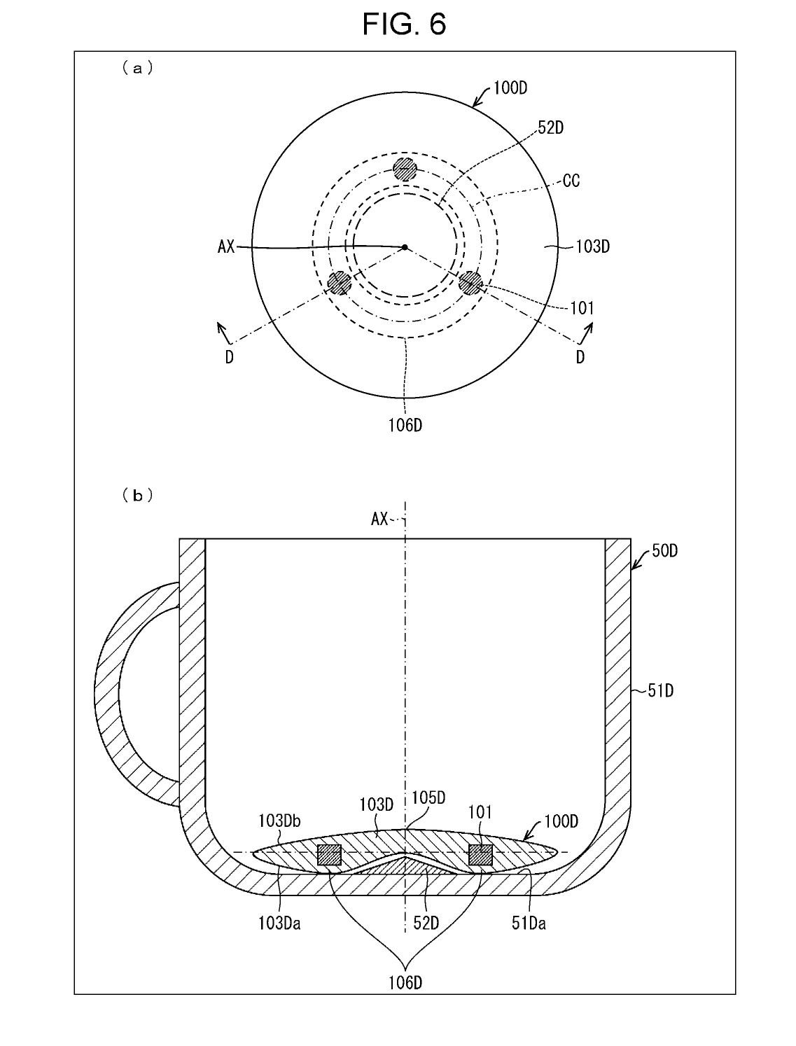

Referring to FIGS. 6(a) and 6(b), a fourth embodiment of the present invention will be described. Except for the structures described in the present embodiment, the fourth embodiment is the same as the first to third embodiments.

FIG. 6(a) is a top view of a stirring element 100D according to the fourth embodiment of the present invention. FIG. 6(b) is a sectional view of a stirring unit 50D in which the stirring element 100D shown in FIG. 6(a) is placed in a stirring container 51D. This sectional view is taken along line D-D of FIG. 6(a) and seen in the direction of arrows.

The milk preparation device 1A (see FIG. 3) may include the stirring unit 50D, instead of the stirring unit 50. Description of the milk preparation device body 2 of the milk preparation device 1A, which is the same as that described in the first embodiment with reference to FIG. 3, will be omitted.

The stirring unit 50D includes the stirring container 51D and the stirring element 100D.

The stirring container 51D includes a protruding portion 52D, instead of the protruding portion 52 of the stirring container 51 (see FIG. 1). In other respects, the stirring container 51D is the same as the stirring container 51.

The protruding portion 52D has a conical shape. In plan view, the protruding portion 52D is circular. The apex of the protruding portion 52D is located on the rotation axis AX of the stirring element 100D.

The stirring element 100D includes a disc portion 103D and a plurality of magnets 101. A back surface 103Da of the disc portion 103D, which faces a bottom surface 51Da of the stirring container 51D, has a central portion (a portion overlapping the protruding portion 52D) that is recessed.

The back surface 103Da of the stirring container 51D includes an adaptation portion 106D that projects concentrically with respect to the rotation axis AX of the stirring element 100D so as to surround the outer periphery of the protruding portion 52D, which is circular in plan view. The back surface 103Da of the adaptation portion 106D has a shape that gradually bulges from an edge portion of the stirring element 100D toward a contact portion with the bottom surface 51Da, which is the ridge of the adaptation portion 106D. The back surface 103Da of the adaptation portion 106D has a shape that gradually bulges from the center toward the ridge of the adaptation portion 106D. The adaptation portion 106D covers the protruding portion 52D of the stirring container 51D.

A front surface 103Db of the stirring element 100D, which is opposite to the back surface 103Da, has a central portion 105D (a portion located on the rotation axis AX) that bulges. That is, the front surface 103Db of the stirring element 100D has a shape that gradually bulges from the edge portion toward the central portion 105D. In other words, the front surface 103Db of the stirring element 100D has a tapered shape that is gradually inclined from a central portion 105A toward the edge portion.

With the stirring element 100D, compared with a shape such that the front surface 103Db is flat, it is possible to reduce resistance due to the flow of a liquid during stirring and to further suppress generation of bubbles. Because the front surface 103Db has a shape that is gradually inclined from the central portion 105D of toward the edge portion, when a user places powdered milk PM into the stirring container 51D, the shape functions to efficiently distribute the powdered milk PM in the stirring container 51D while preventing the powdered milk PM from accumulating on the central portion 105D of the stirring element 100D. Therefore, it is possible to prevent generation of an undissolved part of the powdered milk PM. In addition, compared with a case where the front surface 103Db of the stirring element 100D has a flat shape, this structure is effective in reducing resistance of a water flow during stirring. Therefore, it is possible to further prevent generation of bubbles in the milk.

Because the adaptation portion 106D of the back surface 103Da of the stirring element 100D is annular, the stirring ability the can be further improved. Moreover, because the center of gravity of the annular adaptation portion 106D is located on the rotation axis AX, the stirring element 100D can stably rotate.

Because the adaptation portion 106D has a shape that gradually bulges from the edge portion toward the ridge of the adaptation portion 106D, the adaptation portion 106D functions to reduce resistance of a water flow (flow of liquid) during stirring and to reduce frictional resistance between the stirring container 51D and the stirring element 100D. The adaptation portion 106D may have a hemispherical sectional shape.

With the milk preparation device 1A including the stirring element 100D, it is possible to efficiently prepare milk while preventing generation of an undissolved part of the powdered milk PM.

### Fifth Embodiment

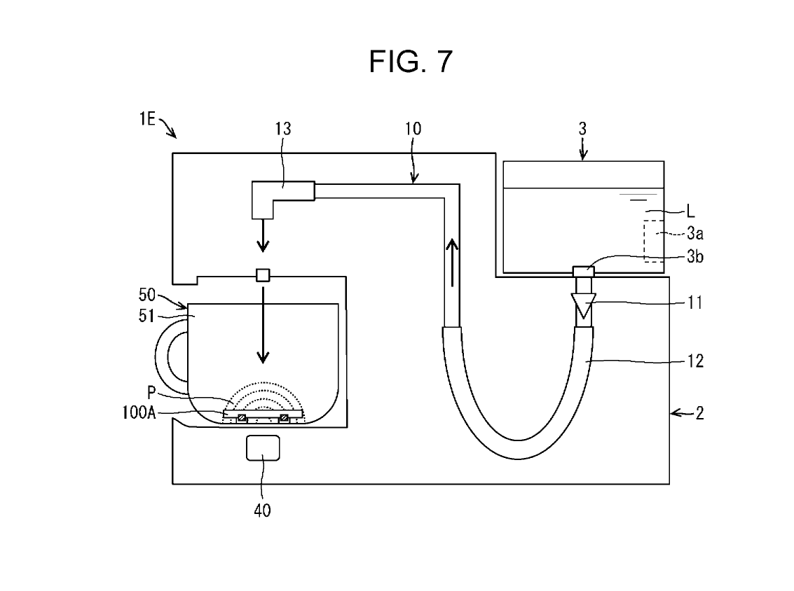

Referring to FIG. 7, a fifth embodiment of the present invention will be described. Except for the structures described in the present embodiment, the fifth embodiment is the same as the first to fourth embodiments.

FIG. 7 is a sectional view of a beverage generating device 1E according to the fifth embodiment. The funnel 20, the cooling portion 30, the duct 33B, the air outlet 34, and the thermistor TN, which are included in the milk preparation device 1A (see FIG. 3), are omitted from the beverage generating device 1E. In other respects, the beverage generating device 1E is the same as the milk preparation device 1A.

With the structure of the beverage generating device 1E, it is possible to obtain the beverage generating device 1E, which includes the stirring unit 50 in which the stirring element 100A is disposed, at low cost.

The material of a mixture used in the beverage generating device 1E is not limited to powdered milk. For example, various types of powder P to be stirred, such as instant coffee or green tea powder, may be used. By supplying the powder P and a liquid L into the stirring container 51 and mixing the mixture by using the stirring element 100A, it is possible to generate a beverage that contains only a small amount of bubbles.

By controlling the rotation speed of the stirring element 100A in accordance with the amount of the liquid L supplied to the stirring container 51, it is possible to provide a beverage with a uniform amount of bubbles even if the amount of the supplied liquid L differs from a specified amount. Also when mixing a beverage that should not contain bubbles, it is possible to provide the beverage reliably without generating bubbles even if the amount of the liquid L differs from a specified amount.

### Sixth Embodiment

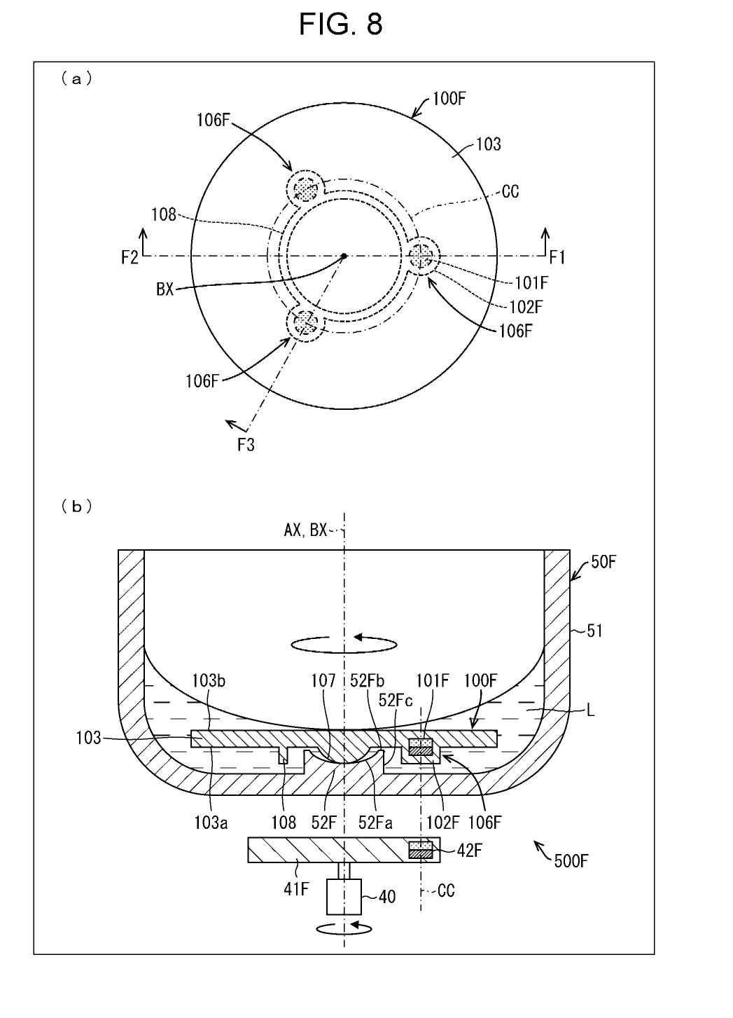

Referring to FIGS. 8 to 10, a sixth embodiment of the present invention will be described. Except for the structures described in the present embodiment, the sixth embodiment is the same as the first to fifth embodiment.

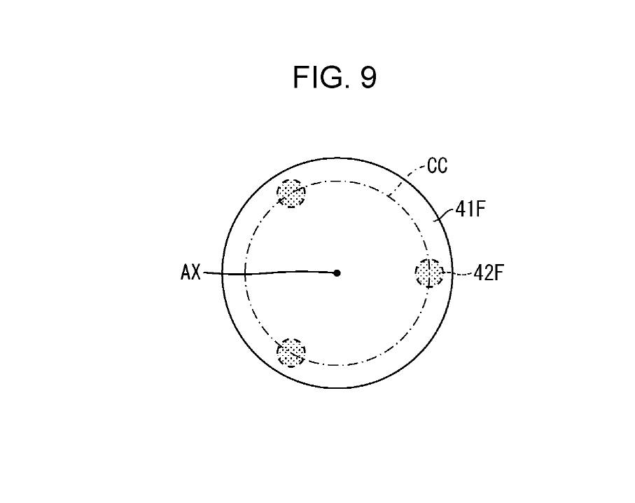

FIG. 8(a) is a top view of a stirring element 100F according to the present embodiment. FIG. 8(b) is a sectional view of a stirring mechanism 500F that includes a stirring unit 50F in which the stirring element 100F illustrated in FIG. 8(a) is placed in a stirring container 51, the stirring motor 40 set below the stirring unit 50F, and a rotary induction plate 41F (rotary drive unit) attached to the rotation shaft of the stirring motor 40. The sectional view is taken along line F1-F2 of FIG. 8(a) and seen in the direction of arrows. FIG. 9 is a top view of the rotary induction plate 41F.

The milk preparation device 1A (see FIG. 3) may include the stirring mechanism 500F, instead of a stirring mechanism that includes the stirring unit 50, the stirring motor 40, and a rotary induction plate (not shown). Description of the milk preparation device body 2 of the milk preparation device 1A, which is the same as that described in the first embodiment with reference to FIG. 3, will be omitted.

(Stirring Container 51)

The stirring container 51 is a hollow-cylindrical container whose central axis is the axis AX. A solid-cylindrical support portion 52F (container-side protruding portion), whose central axis is the axis AX, is formed on an inner bottom surface of the stirring container 51. The support portion 52F is integrally formed with the stirring container 51 and serves as a contact support portion when rotating the stirring element 100F about the axis AX.

At the upper surface (top) of the support portion 52F, a support curved surface 52Fa (container-side top recessed portion) and an upper surface guide 52Fb (ring-shaped wall) are disposed. The support curved surface 52Fa is a concave surface (concavely curved surface), and the height of the support curved surface 52Fa from the bottom surface of the stirring container 51 is the lowest on the axis AX. The upper surface guide 52Fb is a peripheral portion of the support curved surface 52Fa, and sticks out upward from a part of the support portion 52F where the height from the bottom surface of the stirring container 51 is the largest. Each of the support curved surface 52Fa and the upper surface guide 52Fb has a shape that is rotationally symmetric about the axis AX. In other words, the upper surface guide 52Fb is a ring-shaped projection. A side surface of the support portion 52F will be referred to as a side guide 52Fc.

In the present embodiment, the inside diameter Φ of the stirring container 51 is about 110 mm, and the height of the stirring container 51 is about 70 mm. The diameter Φ of the support portion 52F is about 20 mm, the height of the support portion 52F from the bottom surface on the axis AX is about 5.1 mm, the height of the upper surface guide 52Fb from the bottom surface is about 5.9 mm, and the curvature R of the support curved surface 52Fa is about 100 mm.

(Stirring Element 100F)

The stirring element 100F includes a disc-shaped plate portion 103, three magnets 101F, and a rib-shaped ring 108 (first ring-shaped projecting portion). In the following description, the central axis of the plate portion 103 will be denoted by BX. In the present embodiment, the outside diameter Φ of the stirring element 100F is about 80 mm.

When the stirring element 100F is rotating stably, in other words, rotating in a state in which the surface of the plate portion 103 is maintained horizontally, the axis BX is parallel to the central axis AX of the stirring container 51. On the other hand, when the stirring element 100F is rotating unstably, in other words, rotating in a state in which the surface of the plate portion 103 is not maintained horizontally but is inclined, the axis BX is also inclined and has an angle with respect to the axis AX.

The ring 108 is a protruding portion formed inside of the magnets 101F on the back surface 103a around the axis BX. In the present embodiment, the inside diameter Φ of the ring 108 is about 27 mm, and the height of the ring 108 from the back surface 103a is about 3.5 mm.

Moreover, a smooth axial curved surface 107 (contact portion, stirring-element-side protruding portion) is formed on the back surface 103a. The shape of the axial curved surface 107 is rotationally symmetric about the axis BX. The axial curved surface 107 is a convex surface (convexly curved surface) whose height from the back surface 103a is the largest on the axis BX. The axial curved surface 107 has a curvature smaller than the curvature of the support curved surface 52Fa. In the present embodiment, the height of the axial curved surface 107 from the back surface 103a on the axis BX is about 2.3 mm, and the curvature R of the axial curved surface 107 is about 30 mm.

The structures of the support curved surface 52Fa and the axial curved surface 107 may be reversed. That is, the support curved surface 52Fa may be a convex surface relative to the upper surface of the support portion 52F, and the axial curved surface 107 may be a concave surface relative to the back surface 103a. In this case, the support curved surface 52Fa has a curvature smaller than the curvature of the axial curved surface 107.

Each of the magnets 101F is a neodymium magnet having a solid-cylindrical shape. Three magnets 101F are disposed in the back surface 103a of the plate portion 103. To be specific, the three magnets 101F are disposed so that the centers thereof are arranged at regular intervals on a support-portion rotation circle CC centered around the axis BX. In the present embodiment, the diameter Φ of each of the magnets 101F is about 8 mm, and the thickness of the magnet 101F is about 5 mm. The diameter Φ of the support-portion rotation circle CC is about 40 mm.

The magnets 101F are integrally formed with the body of the stirring element 100F by insert molding. Alternatively, the magnets 101F may be embedded in the stirring element 100F by inserting the magnets 101F into insertion holes formed in the stirring element 100F and then performing ultrasonic welding so as to cover the insertion holes. Therefore, the magnets 101F are not exposed to the outside of the stirring element 100F. Portions of the stirring element 100F that cover the magnets 101F will be referred to as projecting portions 102F. Three projecting portions 102F that cover the three magnets 101F and the ring 108 constitute an adaptation portion 106F that is adapted to the support portions 52F of the stirring container 51 and that serves to appropriately position the stirring element 100F.

In the present embodiment, the polarities of the three magnets 101F (directions from the south pole toward the north pole) are parallel to the axis BX and are in the same direction. Therefore, irrespective of the direction in which the stirring element 100F is placed in the stirring container 51, the magnets 101F and induction magnets 42F of the rotary induction plate 41F can be easily coupled to each other.

(Rotary Induction Plate 41F)

As illustrated in FIG. 8(b), the rotary induction plate 41F is fixed to the stirring motor 40 and disposed below the stirring container 51. The rotation center of the rotary induction plate 41F substantially overlaps the axis AX, which is the central axis of the stirring container 51. As illustrated in FIG. 9, three induction magnets 42F are attached to the rotary induction plate 41F on the same support-portion rotation circle CC so as to form pairs with the three magnets 101F of the stirring element 100F. As the stirring motor 40 rotates the rotary induction plate 41F, the stirring element 100F, which is magnetically coupled with the rotary induction plate 41F, synchronously rotates.

The stirring motor 40 and the rotary induction plate 41F are disposed in the milk preparation device body 2 of the milk preparation device 1A. When performing a milk preparation operation, the stirring unit 50F, which includes the stirring container 51 and the stirring element 100F, is set on the milk preparation device body 2 and used. The milk preparation device body 2 includes a positioning mechanism (not shown) for restraining a position at which the stirring container 51 is to be set. Therefore, it is possible to substantially align the rotation center of the rotary induction plate 41F and the axis AX of the stirring container 51 with each other.

(Operation of Stirring Unit 50F)

In general, in a stirring mechanism typified by the milk foamer described in PTL 1, a plurality of components are used as the central shaft of the stirring element (rotational body) in order to realize improvement of rotational stability, reduction of frictional wear, and reduction of noise. However, as in the case of the milk preparation device according to the present embodiment, which is used to generate milk for an infant, who has weak immunity, it is necessary to reliably clean and sterilize components to which milk adheres every time the device is used. Therefore, it is preferable that the components of the stirring mechanism have simple shapes and the number of the components be reduced to a minimum. Moreover, ease of removing the components is important.

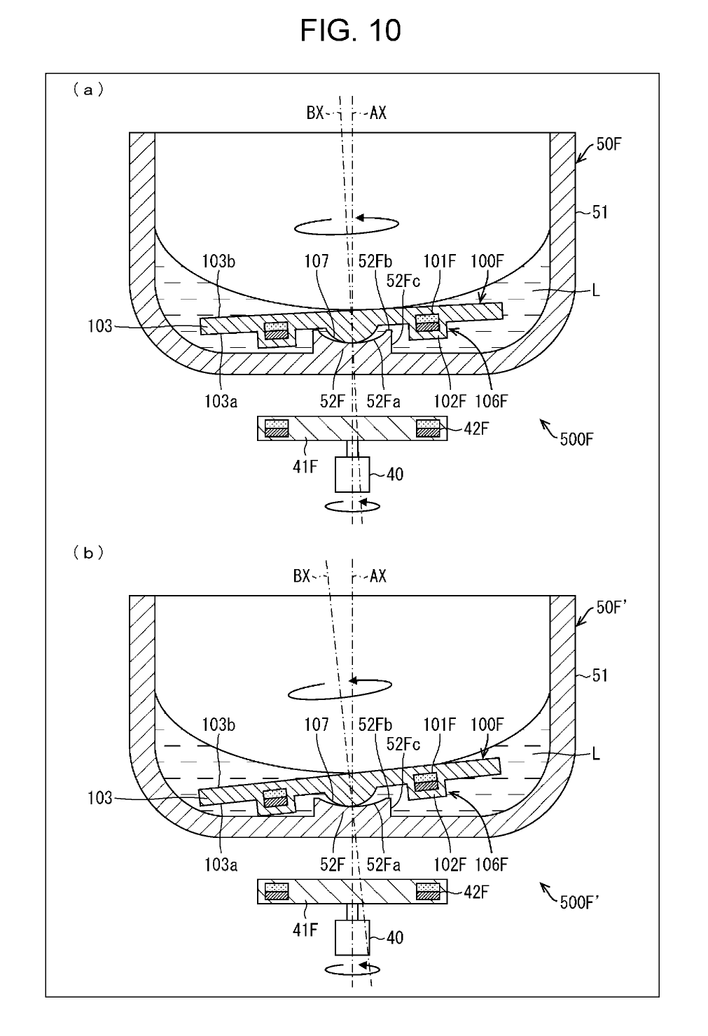

Here, a case where the number of components of the stirring mechanism is reduced to a minimum and ease of attaching/removing the components is increased, that is, a case where the components are not mechanically joined to each other and a user is ready to start stirring by only appropriately combining the components will be considered. This case has a disadvantage in that rotation of the stirring element (rotational body) tends to become unstable, because the rotation axis is not uniquely determined. When the stirring element 100F is rotated by magnetic coupling as in the present embodiment, the rotation of the stirring element 100F may become unstable, and thereby magnetic forces between the magnets may vary. Finally, loss of magnetic coupling (loss of synchronism) may occur and the rotation of the stirring element 100F may stop. A method of solving this problem in the present embodiment will be described with reference to FIG. 10.

FIG. 10(a) is a schematic sectional view of the stirring mechanism 500F according to the present embodiment, illustrating a case where the rotation speed of the stirring element 100F changes from a low speed to a high speed. FIG. 10(b) is a schematic sectional view of a stirring mechanism 500F′ according to a comparative example, illustrating a case where the rotation speed of the stirring element 100F changes from a low speed to a high speed. These sectional views are taken along line F1-F3 of FIG. 8(a) and seen in the direction of arrows.

In the stirring unit 50F according to the present embodiment, the difference between the height of the upper surface guide 52Fb, which is the highest point of the support portions 52F of the stirring container 51, and the height of the support curved surface 52Fa on the axis AX is larger than that of the stirring unit 50F′ according to the comparative example described below. Accordingly, the distance between the upper surface guide 52Fb and the back surface 103a of the stirring element 100F is small. Therefore, when the rotation speed of the stirring element 100F is zero, as illustrated in FIG. 10(a), the stirring element 100F is stationary in a state in which the stirring element 100F is in contact with two points, which are a point of the support curved surface 52Fa of the support portion 52F and a point of the upper surface guide 52Fb of the support portion 52F. Therefore, the inclination of the axis BX relative to the axis AX is smaller than that of the stirring unit 50F′ according to the comparative example described below.

On the other hand, in the stirring unit 50F′ according to the comparative example, the difference between the height of the upper surface guide 52Fb, which is the highest point of the support portions 52F of the stirring container 51, and the height of the support curved surface 52Fa on the axis AX is smaller than that of the stirring unit 50F according to the present embodiment. Accordingly, the distance between the upper surface guide 52Fb and the back surface 103a of the stirring element 100F is large. Therefore, when the rotation speed of the stirring element 100F is zero, as illustrated in FIG. 10(b), the stirring element 100F is stationary in a state in which the stirring element 100F is in contact with two points, which are a point of an inner wall of the support curved surface 52Fa of the support portion 52F and a point of the inner bottom surface of the stirring container 51. Therefore, the inclination of the axis BX relative to the axis AX is larger than the inclination in the stirring unit 50F according to the present embodiment.

In each of the stirring units 50F and 50F′, when the stirring motor 40 is rotated, the stirring element 100F starts rotating in a state in which the stirring element 100F is in contact with the stirring container 51 at the two points described above. In an acceleration range in which the rotation speed of the stirring element 100F changes from a low speed to a high speed (for example, about 1000 rpm), the balance between attraction forces between the magnets 101F of the stirring element 100F and induction magnets 42F of the rotary induction plate 41F and the centrifugal force generated as the stirring element 100F rotates is unstable. Therefore, in the acceleration range, vibration of the stirring element 100F tends to occur.

In particular, in the stirring unit 50F′ according to the comparative example, because the inclination of the axis BX relative to the axis AX is large as illustrated in FIG. 10(b), the attraction forces between the magnets 101F of the stirring element 100F and the induction magnets 42F of the rotary induction plate 41F vary considerably between the magnets. On the other hand, in the stirring unit 50F according to the present embodiment, because the inclination of the axis BX relative to the axis AX is small as illustrated in FIG. 10(a), the attraction forces between the magnets vary only slightly between the magnets. Therefore, in the stirring unit 50F′ according to the comparative example, the stirring element 100F easily vibrates up and down, compared with the stirring unit 50F according to the present embodiment.

As illustrated in FIG. 10(b), in the stirring unit 50F′ according to the comparative example, the stirring element 100F is in contact with the stirring container 51 at a position separated outward from the axis BX. Therefore, the inclination of the stirring element 100F is large, and a large noise is generated due to contact between the stirring element 100F and the stirring container 51. On the other hand, as illustrated in FIG. 10(a), in the stirring unit 50F according to the present embodiment, the stirring element 100F is in contact with the stirring container 51 at a position near the axis BX. Therefore, the inclination of the stirring element 100F is small, and noise generated due to contact between the stirring element 100F and the stirring container 51 is reduced. Moreover, with the stirring unit 50F according to the present embodiment, because the inclination is small, the time needed by the stirring element 100F to change to a stably rotating state is reduced. The stably rotating state is a state in which the rotation speed of the stirring element 100F is sufficiently high and the centrifugal force due to the rotation of the stirring element 100F is larger than the attraction forces between the magnets 101F of the stirring element 100F and the induction magnets 42F of the rotary induction plate 41F. In this state, the stirring element 100F performs a stable horizontal rotation in a state in which the stirring element 100F is in contact with the stirring container 51 at only one point near the axis BX.

Examples of a method for further suppressing vibration of the stirring element 100F to rotate the stirring element 100F stably without causing loss of synchronism include a method of increasing restraint on the rotation by reducing a gap between the inside diameter of the rib-shaped ring 108 of the stirring element 100F and the outside diameter of the support portion 52F of the stirring container 51.

However, when stirring a mixture liquid having high viscosity and/or a liquid containing solid matter, horizontal vibration of the stirring element 100F increases. Therefore, contact between the ring 108 of the stirring element 100F and the support portions 52F of the stirring container 51 increases, and contact noise tends to be generated. In the milk preparation device 1A according to the present embodiment, the stirring container 51 is removable from the milk preparation device 1A, and a method of using a positioning structure (not shown) to align the rotation center of the stirring motor 40 with the axis AX of the stirring container 51 is used. Therefore, if the rotation axis of the stirring motor 40 becomes considerably displaced from the axis AX of the stirring container 51, not only noise increases but also rotation may become impossible.

Accordingly, preferably, the size of a gap between the inside diameter of the rib-shaped ring 108 of the stirring element 100F and the outside diameter of the support portion 52F of the stirring container 51 is appropriately determined in accordance the positioning structure, the type of liquid to be stirred, and the loudness of contact noise.

(Advantageous Effects of Stirring Unit 50F)

In the stirring unit 50F, a part of the stirring element 100F corresponding to the rotation center contacts the stirring container 51, and the other parts do not contact the stirring container 51. Therefore, friction during rotational motion is further reduced. Moreover, the axial curved surface 107 of the stirring element 100F is restrained by the support curved surface 52Fa of the stirring container 51, which is a recessed portion. Therefore, it is possible to suppress occurrence of loss of synchronism of the stirring element 100F.

The curvature of the axial curved surface 107 of the stirring element 100F is larger than the curvature of the support curved surface 52Fa of the stirring container 51. Therefore, the stirring element 100F can stably rotate, because the rotation center can return to the center of the support curved surface 52Fa even if the rotation center of the stirring element 100F becomes displaced from the center of the support curved surface 52Fa. With the upper surface guide 52Fb, which is formed at an edge portion of the support curved surface 52Fa of the stirring container 51, it is possible to further suppress occurrence of loss of synchronism of the stirring element 100F.

As illustrated in FIG. 8(b), when the stirring element 100F is rotating at a high speed and stirring milk, due to a centrifugal force, the liquid surface rises at the outer periphery in the stirring container 51 and the liquid surface falls at the center in the stirring container 51. In this case, the surface area of milk increases compared with a case where the liquid surface is horizontal. Accordingly, the heat dissipation area of milk increases and the milk can be cooled in a short time.

As illustrated in FIG. 8(a), the projecting portions 102F, which cover the magnets 101F, each have a shape that projects further outward than the rib-shaped ring 108. Because the projecting portions 102F are disposed on the back surface 103a of the stirring element 100F, when stirring milk by using the stirring unit 50F, even if the center of the liquid surface falls, the projecting portions 102F are located constantly in the milk. As a result, it is possible to efficiently stir the milk without pulling air into the milk.

On the other hand, the front surface 103b of the stirring element 100F, that is, a surface on a side at which the interface between milk and air is present, is a smooth planar surface that does not have a projection. The stirring unit 50F can suppress generation of bubbles even when the stirring element 100F rotates at a high speed.

Due to the change in the liquid surface described above, the size of the stirring container 51 needs to be larger than the amount of milk to be prepared. By making the size of the stirring container 51 sufficiently large, it is possible to cool milk more easily and to reduce the amount of bubbles contained in the milk. Because a hot liquid supply hole 6 of the milk preparation device 1A is located near the center of the stirring container 51, generation of an undissolved part of powdered milk near the center of the front surface 103b of the stirring element 100F is suppressed. Accordingly, with the stirring unit 50F including the stirring element 100F, it is possible to prepare milk containing only a small amount of bubbles and only a small amount of undissolved powdered milk.

### Seventh Embodiment

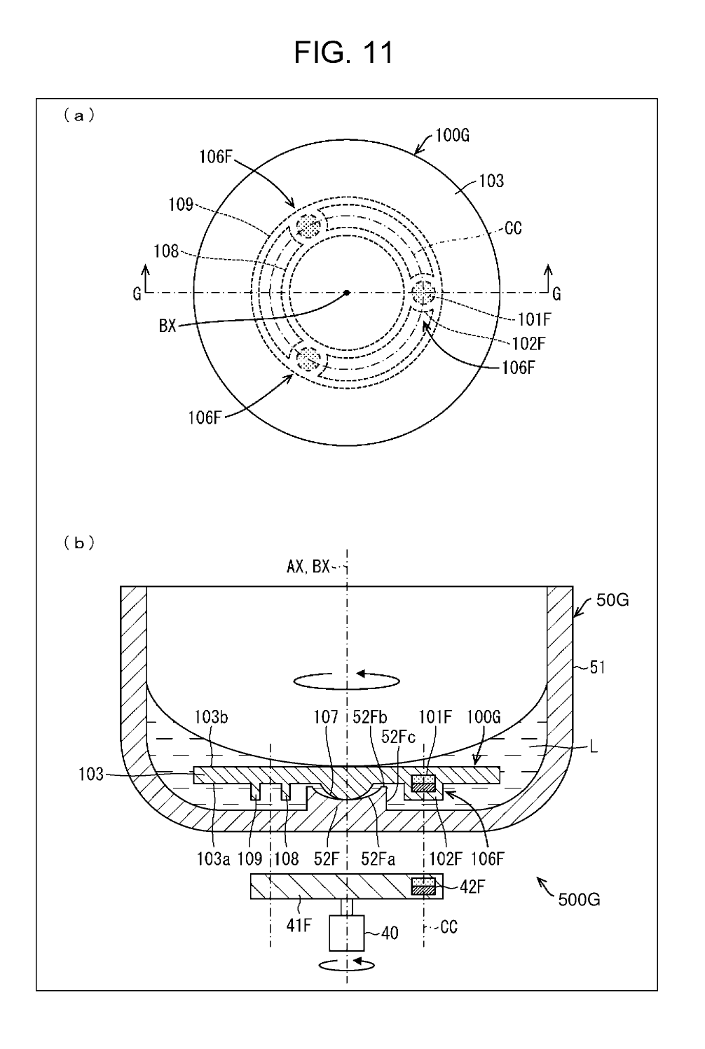

Referring to FIG. 11, a seventh embodiment of the present invention will be described. Except for the structures described in the present embodiment, the seventh embodiment is the same as the first to sixth embodiments.

FIG. 11(a) is a top view of a stirring element 100G according to the present embodiment. FIG. 11(b) is a sectional view of a stirring mechanism 500G that includes a stirring unit 50G in which the stirring element 100G illustrated FIG. 11(a) is placed in a stirring container 51; the stirring motor 40; and the rotary induction plate 41F according to the sixth embodiment. This sectional view is taken along line G-G of FIG. 11(a) and seen in the direction of arrows.

The stirring unit 50G includes the stirring container 51 and the stirring element 100G. The stirring element 100F (see FIG. 8) according to the sixth embodiment includes the projecting portions 102F, which cover the three magnets 101F; and the rib-shaped ring 108 on the back surface 103a. Because the projecting portions 102F are disposed outside of the rib-shaped ring 108, stirring can be accelerated. In contrast, on the back surface 103a of the stirring element 100G according to the present embodiment, in addition to the projecting portions 102F and the rib-shaped ring 108, a rib-shaped outer ring 109 (second ring-shaped projecting portion) is disposed. The outer ring 109 is disposed concentrically with the ring 108 so as to surround the outer periphery of the projecting portions 102F. In other respects, the stirring element 100G is the same as the stirring element 100F according to the sixth embodiment.

In the stirring element 100G according to the present embodiment, the projecting portions 102F, which generate resistance when the stirring element 100G rotates, are surrounded by the outer ring 109. Therefore, it is possible to considerably reduce rotational resistance. Accordingly, when used to stir a liquid, it is possible to increase rotation speed stably compared with the stirring element 100F according to the sixth embodiment.

In particular, in a case where a liquid to be stirred has high viscosity or in a case where a liquid including solid matter is stirred, the concentration of the liquid becomes uneven while being dissolved, and therefore a stirring element that is not mechanically restrained tends to vibrate unstably. Also in such a case, the stirring element 100G can stir the liquid by generating a centrifugal force with the smooth front surface 103b that does not have a projection.

In the sixth and seventh embodiments, all of the magnets that are used (the magnets 101F and the induction magnets 42F) are solid-cylindrical neodymium magnets each having Φ of 8 mm and a height of 5 mm. However, these magnets need not be the same. The materials, the sizes, or the directions of the magnets may differ among the magnets in order to adjust the magnetic force that couples the stirring element and the rotary induction plate in consideration of the viscosity of liquid to be stirred and the like.

### Eighth Embodiment

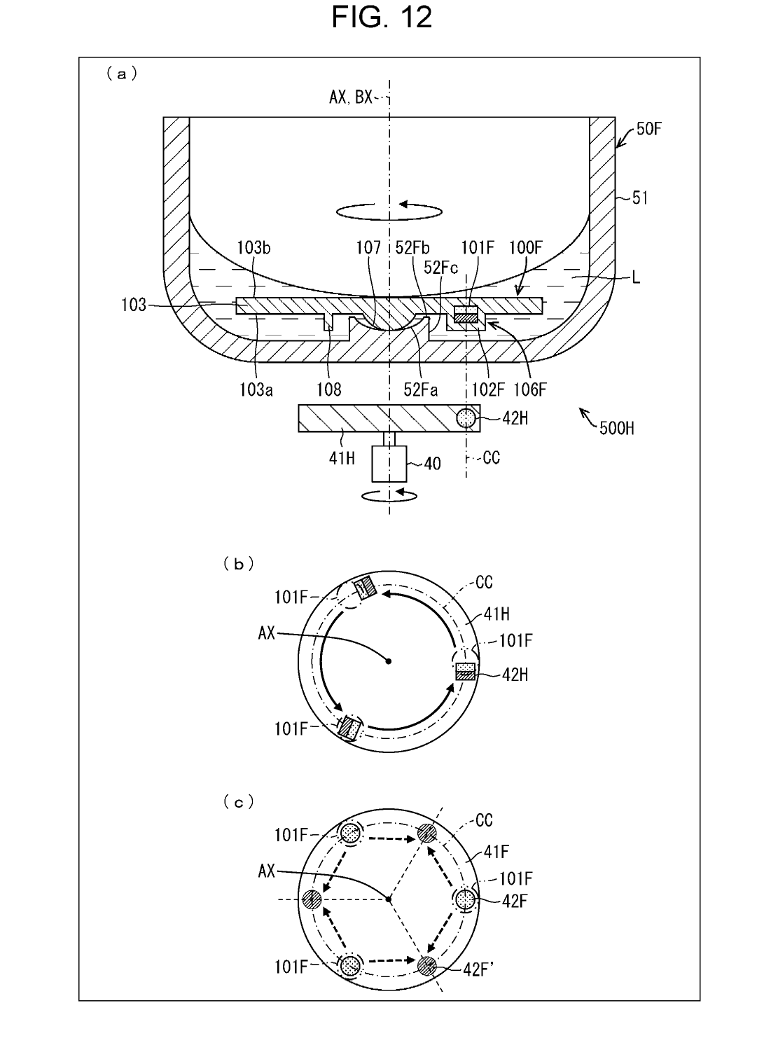

Referring to FIG. 12, an eighth embodiment of the present invention will be described. Except for the structures described in the present embodiment, the eighth embodiment is the same as the first to seventh embodiments.

FIG. 12(a) is a sectional view of a stirring mechanism 500H including a rotary induction plate 41H according to the present embodiment. FIG. 12(b) is a top view of the rotary induction plate 41H illustrated in FIG. 12(a). FIG. 12(C) is a top view of the rotary induction plate 41F according to the sixth embodiment, which is to be compared with the rotary induction plate 41H. In FIGS. 12(b) and 12(c), induction magnets 42H and 42F, which are disposed in the rotary induction plates 41H and 41F, are explicitly shown.

The stirring mechanism 500H according to the sixth embodiment differs from the stirring mechanism 500F according to the sixth embodiment in that the stirring mechanism 500H includes the rotary induction plate 41H instead of the rotary induction plate 41F. In other respects, the stirring mechanism 500H is the same as the stirring mechanism 500F.

In the present embodiment, the polarities of three induction magnets 42H of the rotary induction plate 41H are in the counterclockwise direction in plan view along the support-portion rotation circle CC (tangential direction of the support-portion rotation circle CC). That is, the directions of the induction magnets 42H are perpendicular to the directions of the induction magnets 42F according to the sixth embodiment.

In the stirring mechanism 500F according to the sixth embodiment, the three induction magnets 42F of the rotary induction plate 41F (see FIG. 8) and the three magnets 101F of the stirring element 100F are arranged so that the directions of the polarities thereof are all the same. Therefore, as schematically illustrated in FIG. 12(c), it can be interpreted that opposite-polarity spots 42F′, having polarities opposite to those of the induction magnets 42F, are formed in the rotary induction plate 41F. That is, the induction magnets 42F and the opposite-polarity spots 42F′ are alternately arranged on the support-portion rotation circle CC of the rotary induction plate 41F, and, accordingly, lines of magnetic force are formed as indicated by dotted-line arrows in FIG. 12(c).

If the stirring element 100F suffers a large disturbance while stirring a liquid and continues stirring, the rotation of the stirring element 100F may not be able to follow the rotation speed of the rotary induction plate 41F, and, finally, loss of magnetic coupling between the rotary induction plate 41F and the stirring element 100F (loss of synchronism) may occur. Examples of the disturbance includes a situation in which a lump of solid matter firmly adheres to a point on the outer periphery of the front surface 103b of the stirring element 100F and the center of gravity of the stirring element 100F becomes considerably displaced.

At this time, because the stirring motor 40 is controlled so as to rotate at a target rotation speed, if loss of synchronism of the stirring element 100F occurs, the electric current that flows in the stirring motor 40 decreases in accordance with decrease of a load on the stirring motor 40. If the change in the electric current is large, it is possible to detect malfunctioning based on the difference in electric current and to inform a user of occurrence of loss on synchronism by using a beep sound or the like.

However, when performing an operation of generating milk by stirring hot water and powdered milk, the amount of milk generated per operation is in the range of 80 ml to 240 ml. Therefore, the load applied to the stirring motor 40 varies in accordance with, for example, the amount of milk and a timing at which loss of synchronism occurs, and it is difficult to reliably detect malfunctioning irrespective of the timing of loss of synchronism. If loss of synchronism of the stirring element 100F is not detected, the stirring motor 40 continues rotating in a state in which synchronism is lost.

If loss of synchronism occurs in the stirring unit 50F according to the sixth embodiment and the stirring motor 40 continues idling, the rotary induction plate 41F continues rotating at a target rotation speed, and the stirring element 100F becomes substantially stationary in the rotation direction in a state in which the stirring element 100F is fitted onto the support portions 52F of the stirring container 51. To be precise, because the rotary induction plate 41F continues rotating although the stirring element 100F has lost synchronism, the stirring element 100F is excited by the induction magnets 42F of the rotary induction plate 41F and rotates very slowly in a direction that is the same as the rotation direction of the rotary induction plate 41F.

Therefore, the induction magnets 42F of the rotary induction plate 41F and the opposite-polarity spots 42F′ alternately pass below the magnets 101F of the stirring element 100F, which are substantially stationary in the rotation direction. The magnets 101F of the stirring element 100F are attracted by the induction magnets 42F and repelled by the opposite-polarity spots 42F′. That is, the stirring element 100F vibrates up and down by being attracted and repelled repeatedly. The stirring element 100F, while vibrating up and down, repeatedly contacts the support portions 52F of the stirring container 51, and continues generating very loud noise.

In particular, for a newborn infant, it is necessary to prepare milk at night and feed the infant. In such a circumstance, generation of noise should be suppressed, because the noise causes mental stress in the infant and a person who prepares milk.

In contrast, in the rotary induction plate 41H according to the present embodiment, the induction magnets 42F generate magnetic forces in one direction with respect to the rotation direction, as schematically shown by solid-line arrows in FIG. 12(b). Therefore, even if loss of synchronism of the stirring element 100F occurs and the stirring motor 40 continues idling, the stirring element 100F vibrates up an down only very slightly. As a result, noise that is generated due to contact between the stirring element 100F and the support portions 52F of the stirring container 51 is considerably suppressed.

Accordingly, even if loss of synchronism of the stirring element 100F cannot be detected from a change in electric current flowing in the stirring motor 40, mental stress that an infant and a person who prepares milk may suffer is considerably reduced.

### Ninth Embodiment

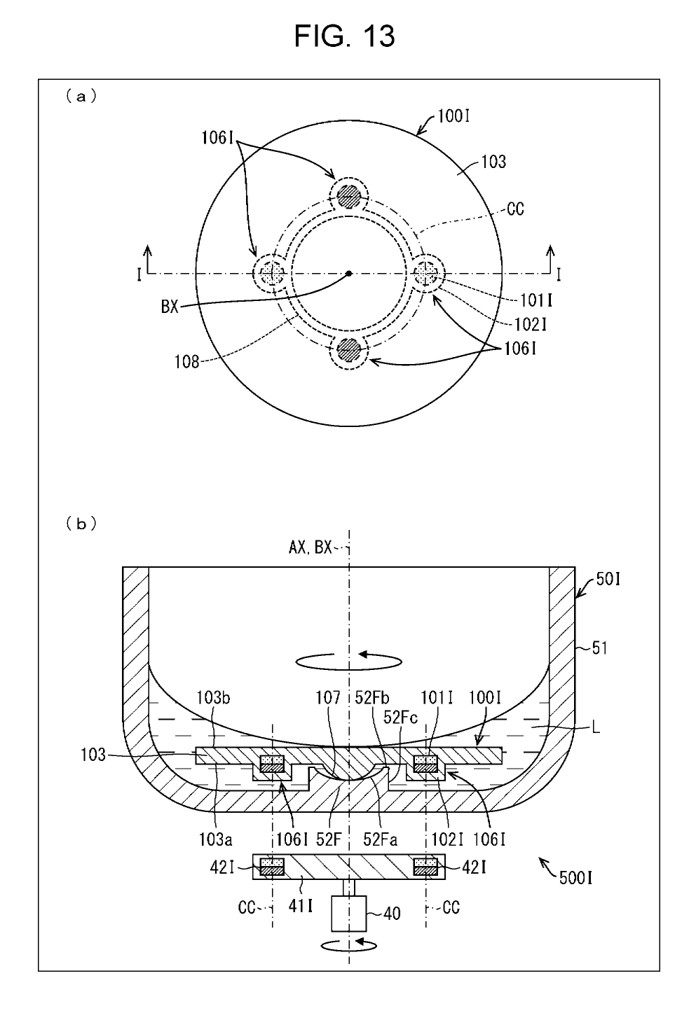

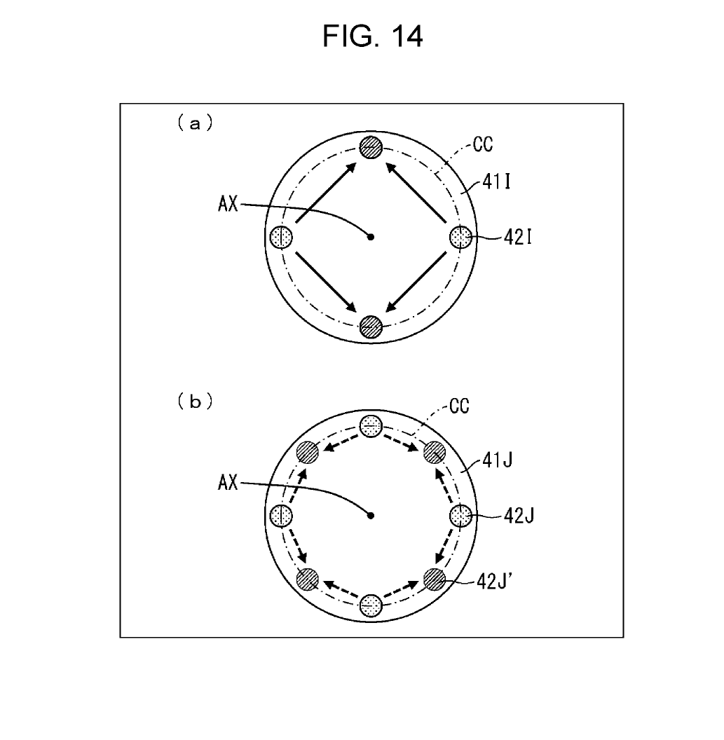

Referring to FIGS. 13 and 14, a ninth embodiment of the present invention will be described. Except for the structures described in the present embodiment, the ninth embodiment is the same as the first to eighth embodiments.

FIG. 13(a) is a top view of a stirring element 100I according to the present embodiment. FIG. 13(b) is a sectional view of a stirring mechanism 500I including a stirring unit 50I in which the stirring element 100I illustrated in FIG. 13(a) is placed in a stirring container 51. This sectional view is taken along line I-I of FIG. 13(a) and seen in the direction of arrows. FIG. 14(a) is a top view of a rotary induction plate 41I included in the stirring mechanism 500F according to the present embodiment. FIG. 14(b) is a top view of a rotary induction plate 41J, which is to be compared with the rotary induction plate 41I.

The stirring element 100F and the rotary induction plate 41F according to the sixth embodiment each include three magnets, and the six magnets are disposed so that the polarities of the magnets are all in the same direction. In contrast, in the present embodiment, the stirring element 100I includes four magnets 101I as illustrated in FIGS. 13(a) and 13(b). The four magnets 101I are disposed so that the polarities of adjacent magnets are opposite to each other. Moreover, as illustrated in FIG. 14(a), the rotary induction plate 41I includes four induction magnets 42I. The four induction magnets 42I of the rotary induction plate 41I are disposed so that the polarities of adjacent magnets are opposite to each other.

The four magnets 101I of the stirring element 100I are covered by projecting portions 102I. The four projecting portions 102I constitute an adaptation portion 106I that is adapted to the support portions 52F of the stirring container 51 and that locates the stirring element 100I at an appropriate position.

With the stirring unit 50I according to the present embodiment, the number of magnets for coupling the stirring element 100I and the rotary induction plate 41I is larger than that of the stirring unit 50F according to the sixth embodiment. Therefore, if the strengths of magnetic forces of individual magnets are the same, it is clear that the stirring unit 50I according to the present embodiment can generate a lager force for coupling the stirring element 100I and the rotary induction plate 41I than the stirring unit 50F according to the sixth embodiment and loss of synchronism is less likely to occur. However, as the number of magnets increases, the cost of manufacturing the stirring unit 50I according to the present embodiment becomes higher than that of the stirring unit 50F according to the sixth embodiment.

In order to suppress an increase in the manufacturing cost, the magnetic forces of magnets used in the stirring unit 50I according to the present embodiment may be made weaker than the magnetic forces of magnets used in the stirring unit 50F according to the sixth embodiment. For example, if the magnetic force of each of the magnets used in the stirring unit 50I according to the present embodiment is ¾ times the magnetic force of each of the magnets used in the stirring unit 50F according to the sixth embodiment, the force of coupling between the stirring element 100I and the rotary induction plate 41I is about the same as the force of coupling in the stirring unit 50F according to the sixth embodiment. Moreover, it is possible to reduce the size of each of the magnets and to suppress an increase in manufacturing cost.

In particular, by reducing the size of each of the magnets 101I of the stirring element 100I, it is possible to reduce the size of each of the projecting portions 102I, which enclose the magnets 101I. Accordingly, it is possible to improve ease of cleaning the stirring element 100I.

In the following description, it is assumed that the magnetic force of each of the magnets used in the stirring unit 50I according to the present embodiment is ¾ times the magnetic force of each of the magnets used in the stirring unit 50F according to the sixth embodiment.

As illustrated in FIG. 13(a), the four magnets 101I of the stirring element 100I are arranged so that the polarities thereof alternately differ from each other. Likewise, as illustrated in FIG. 14(a), the induction magnets 42I of the rotary induction plate 41I are also arranged so that the polarities thereof alternately differ from each other.

FIG. 14(b) is a top view of the rotary induction plate 41J, which is to be compared with the rotary induction plate 41I according to the present embodiment. As illustrated in FIG. 14(b), in the rotary induction plate 41J, the four induction magnets 42J are arranged so that the directions of the polarities thereof are all the same. Therefore, it can be schematically described that opposite-polarity spots 42J′, having polarities opposite to the induction magnets 42J, are formed in the rotary induction plate 41J. That is, in accordance with the alternate arrangement of the induction magnets 42J and the opposite-polarity spots 42J′, lines of magnetic forces are formed as indicted by dotted-line arrows in FIG. 14(b).

However, in reality, the opposite-polarity spots 42J′ are not clearly generated but are generated in vague regions. This is because the lines of magnetic forces from the induction magnets 42J do not converge considerably at the opposite-polarity spots 42J′. Therefore, the rotary induction plate 41J and the stirring element 100I cannot be efficiently coupled.

In contrast, in the rotary induction plate 41I according to the present embodiment illustrated in FIG. 14(a), the induction magnets 42I are arranged so that the polarities thereof alternately differ from each other. Accordingly, lines of magnetic forces generated by the induction magnets 42I, which are indicated by solid-line arrows in FIG. 14(a), converge with high density at the induction magnets 42I. Therefore, the rotary induction plate 41I and the stirring element 100I can be efficiently coupled.

Thus, the stirring element 100I and the rotary induction plate 41I according to the present embodiment, which are attracted to each other by efficient magnetic coupling, have higher resistance to loss of synchronism and enable a more stable stirring operation than in the case where the magnets (see FIG. 14(b)) are arranged so that the polarities are all aligned. That is, the stirring element 100I according to the present embodiment is superior to the stirring element 100F according to the sixth embodiment in that the magnetic force per one magnet can be reduced and more stable stirring rotation becomes possible.

Moreover, when the stirring element 100I loses synchronism in the stirring unit 50I according to the present embodiment and the positional relationship between the stirring unit 50I and the rotary induction plate 41I becomes displaced by 90 degrees with respect to a position where the magnetic coupling force is the strongest, a large repulsion force is generated between the four magnets 101I of the stirring element 100I and the four induction magnets 42I of the rotary induction plate 41I. Because the rotary induction plate 41I continues to be rotated by the stirring motor 40, the large repulsion force generated between the stirring element 100I and the rotary induction plate 41I includes not only a component that is parallel to the axis AX but also a component that is diagonal to the axis AX. Therefore, it was observed that the stirring element 100I, which was not mechanically restrained, lost synchronism in such a way that the ring 108 on the back surface 103a became displaced from the support portions 52F of the stirring container 51.

That is, even if loss of synchronism of the stirring element 100I occurs and the stirring motor 40 continues idling, generation of noise due to contact between the stirring element 100I and the stirring container 51 is suppressed. Thus, even if loss of synchronism of the stirring element 100I cannot be detected from a change in the electric current flowing in the stirring motor 40, mental stress of an infant or a person who prepares milk is considerably reduced.

### Tenth Embodiment

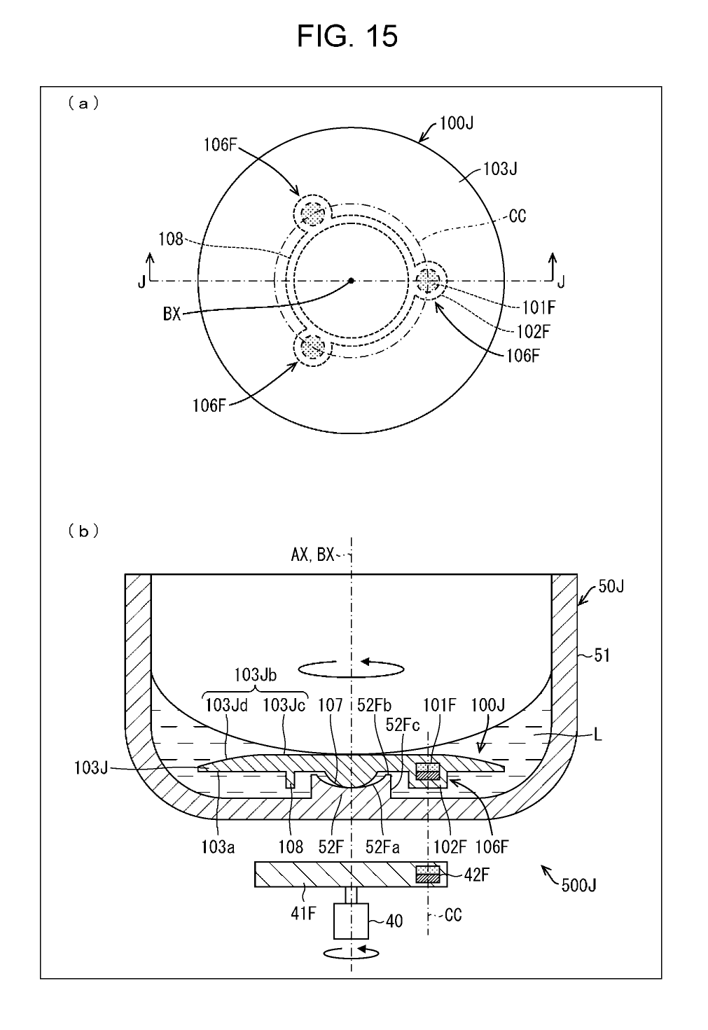

Referring to FIG. 15, a tenth embodiment of the present invention will be described. Except for the structures described in the present embodiment, the tenth embodiment is the same as the first to ninth embodiments.

FIG. 15(a) is a top view of a stirring element 100J according to the present embodiment. FIG. 15(b) is a sectional view of a stirring mechanism 500J including a stirring unit 50J in which the stirring element 100J illustrated in FIG. 15(a) is placed in the stirring container 51, a stirring motor 40 set below the stirring unit 50J, and a rotary induction plate 41F (rotary drive unit) attached to the rotation shaft of the stirring motor 40. This sectional view is taken along line J-J of FIG. 15(a) and seen in the direction of arrows.

The stirring unit 50J includes a stirring container 51 and the stirring element 100J. In the stirring element 100F (see FIG. 8) according to the sixth embodiment, the entirety of the front surface 103b of the plate portion 103 has a flat shape. In contrast, in the stirring element 100J according to the present embodiment, a front surface 103Jb of a plate portion 103J has a shape such that a central portion 103Jc is flat and a peripheral portion 103Jd gradually lowers toward the outside. In other respects, the stirring element 100J is the same as the stirring element 100F according to the sixth embodiment.

The peripheral portion 103Jc of the front surface 103Jb of the stirring element 100J according to the present embodiment is the same as the peripheral portion of the front surface 103Db of the stirring element 100D (see FIG. 6) according to the fourth embodiment. Accordingly, as with the stirring element 100D according to the fourth embodiment, it is possible to reduce resistance due to the flow of liquid during stirring and therefore it is possible to further suppress generation of bubbles.

### SUMMARY

According to a first aspect of the present invention, a stirring element 100 is a stirring element that is shaped like a disc and that is to be placed on a bottom portion (bottom surface 51a) of a stirring container 51 for stirring a liquid. The stirring element is configured to perform rotational motion about a rotation center that is a center of the disc due to a magnetically acting force from outside. The stirring element includes at least one projecting portion 102 at a position on a lower surface 103a of the stirring element separated from the rotation center, the lower surface facing the bottom portion of the stirring container and the projecting portion projecting toward the bottom portion of the stirring container. An upper surface 103b of the stirring element 100, which is opposite to the lower surface, is planar.

With this structure, because the upper surface of the stirring element is planar, as described above, it is possible to suppress generation of a vortex or a turbulent flow from the upper surface of the stirring element due to the rotational motion of the stirring element.

The stirring element includes the projecting portion on the lower surface. Thus, as described above, it is possible to effectively utilize a rotational flow that is generated between the bottom portion of the stirring container and the stirring element and to suppress the effect of a vortex or a turbulent flow, which is generated due to the rotational flow, on the liquid surface. As a result, it is possible to suppress generation of bubbles. Moreover, it is possible to improve the ability (stirring ability) of the stirring element to stir a liquid by rotating. Because the projecting portion is disposed on the lower surface, the projecting portion is not likely to pull air into the liquid. Accordingly, it is possible to suppress generation of bubbles due to the projecting portion.

According to a second aspect of the present invention, in the stirring element according to the first aspect, a peripheral portion of the upper surface may have a shape that is inclined downward toward an outer side. In this case, because resistance due to the flow of a liquid during stirring can be reduced as described above, it is possible to suppress generation of bubbles.

According to a third aspect of the present invention, in the stirring element according to the second aspect, a central portion of the upper surface may have a flat shape.

As in this case, the upper surface of the stirring element need not be completely flat and may have a substantially planar shape when the stirring element is viewed in full scale. For example, the upper surface of the stirring element may have a streamlined shape with respect to the rotational motion. The upper surface may have a shape that does not have a member that generates drag against the liquid.

The projecting portion may extend so that a tip thereof contacts the bottom portion of the stirring container. In this case, it is possible to further improve the stirring ability.

According to a fourth aspect of the present invention, in the stirring element according to the second aspect, the number of the projecting portions on the lower surface may be three or more, and the projecting portions may be disposed concentrically with respect to the rotation center. In this case, compared with a case where the number of the projecting portions is two or less, it is possible to further improve the stirring ability. In a case where the center of gravity of the three or more projecting portions coincides with the rotation center, the stirring element can stably rotate.

According to a fifth aspect of the present invention, in the stirring element according to the second or third aspect, the projecting portion on the lower surface may have an annular shape centered around the rotation center. In this case, it is possible to further improve the stirring ability. Because the center of gravity of the annular projecting portion coincides with the rotation center, the stirring element can stably rotate. As in this case, the projecting portion may have various shapes.

According to a sixth aspect of the present invention, in the stirring element according to the fourth or fifth aspect, the lower surface may gradually bulge from an edge portion toward the projecting portion. In this case, it is possible to reduce resistance due to the flow of a liquid during stirring.

According to a seventh aspect of the present invention, the stirring element according to any one of the second to sixth aspects may further include a magnet for receiving the magnetically acting force, at least a part of the magnet being disposed in the projecting portion. In this case, because the magnet is disposed at a position in the stirring element near the outside, the magnet can easily receive the magnetically acting force from the outside.

An upper-surface projecting portion (separator 105) may be disposed on the upper surface of the stirring element at the rotation center. In this case, for example, when dissolving a material in a liquid and stirring the liquid, even if the material is positioned at the rotation center of the stirring element, the material can easily move to an edge portion of the stirring element due to the upper-surface projecting portion. Accordingly, it is possible to prevent generation of an undissolved part of the material, and, as a result, it is possible to efficiently dissolve the material in the liquid. Because the upper-surface projecting portion does not generate high resistance when the stirring element rotates, it is possible to suppress increase of generation of bubbles.

A plurality of recesses may be formed in the surface of the upper-surface projecting portion. In this case, it is possible to further efficiently dissolve a material.

According to an eighth aspect of the present invention, in the stirring element according to any one of the first to seventh aspects, the upper surface may gradually bulge from an edge portion toward the rotation center. In this case, compared with a case where the upper surface has a flat shape, it is possible to reduce resistance due to the flow of a liquid during stirring and to further suppress generation of bubbles.

According to a ninth aspect of the present invention, a stirring device (milk preparation device 1A) may include the stirring element according to any one of the first to eighth aspects, and a stirring container in which the stirring element is placed. In this case, the stirring device has the same advantageous effects as the stirring element described above.

According to a tenth aspect of the present invention, in the stirring device according to the ninth aspect, the stirring container may include a container-side protruding portion (protruding portion 52) at a position on the bottom portion corresponding to the rotation center, the container-side protruding portion protruding toward the stirring element.

The stirring element may be disposed so as to cover the container-side protruding portion. In this case, the stirring element can stably rotate at the same position without being displaced from the rotation center.

A part of the lower surface of the stirring element facing the container-side protruding portion may contact the container-side protruding portion. In this case, because a position corresponding to the rotation center of the stirring element serves as a contact portion, friction during rotational motion can be further reduced.

According to an eleventh aspect of the present invention, in the stirring device according to the tenth aspect, the container-side protruding portion may include a container-side top recessed portion (support curved surface 52Fa) whose top is recessed; the stirring element may include a stirring-element-side protruding portion (axial curved surface 107) at a position facing the container-side protruding portion, the stirring-element-side protruding portion protruding toward the bottom portion of the stirring container; and a tip of the stirring-element-side protruding portion may contact an inner wall of the container-side top recessed portion. In this case, because the stirring-element-side protruding portion is restrained in the container-side top recessed portion, it is possible to suppress occurrence of loss of synchronism of the stirring element.

Preferably, the container-side top recessed portion has a concavely curved surface, the stirring-element-side protruding portion has a convexly curved surface, and the curvature of the convexly curved surface of the stirring-element-side protruding portion is larger than the curvature of the concavely curved surface of the container-side top recessed portion. In this case, the stirring element can stably rotate, because the rotation center can return to the center of the container-side top recessed portion even if the rotation center of the stirring element becomes displaced from the center of the container-side top recessed portion.

The stirring container may include a ring-shaped wall portion (upper surface guide 52Fb) that protrudes from an edge portion of the container-side top recessed portion toward the stirring element. In this case, it is possible to further reduce occurrence of loss of synchronism of the stirring element.

According to a twelfth aspect of the present invention, in the stirring device according to the tenth or eleventh aspect, the stirring element may include a first ring-shaped projecting portion that projects from the lower surface toward the bottom portion of the stirring container so as to surround the container-side protruding portion of the stirring container. In this case, the stirring element can further stably rotate at the same position without being displaced from the rotation center.

According to a thirteenth aspect of the present invention, in the stirring device according to the twelfth aspect, the stirring element may include at least one dot-shaped projecting portion on the lower surface at a position outside of the first ring-shaped projecting portion (ring 108), the dot-shaped projecting portion projecting toward the bottom portion of the stirring container. In this case, it is possible to further improve the stirring ability of the stirring element.

According to a fourteenth aspect of the present invention, in the stirring device according to the thirteenth aspect, the stirring element may include a second ring-shaped projecting portion (outer ring 109) that projects from the lower surface toward the bottom portion of the stirring container so as to surround the first ring-shaped projecting portion and the dot-shaped projecting portion (projecting portion 102). In this case, it is possible to considerably reduce rotational resistance of the stirring element and to stably increase the rotation speed of the stirring element.

According to a fifteenth aspect of the present invention, in the stirring device according to any one of the ninth to fourteenth aspects, preferably, the stirring device has a placement surface (setting surface 2a) on which the stirring container is placed, and the stirring device further includes a rotary drive unit (stirring motor 40, rotary induction plate 41) for rotating the stirring element by using the magnetically acting force. In this case, the stirring element can stably stir a liquid in the stirring container.

Preferably, the rotary drive unit includes a stirring motor and a rotary induction plate rotated by the stirring motor, the rotary induction plate includes a plurality of induction magnets 42 disposed on a concentric circle, and the stirring element includes a plurality of magnets 101 that are disposed so as to correspond to the plurality of induction magnets of the rotary induction plate. In this case, the plurality of induction magnets of the rotary induction plate and the plurality of magnets of the stirring element are magnetically coupled with each other.

Accordingly, it is possible to rotate the stirring element as the stirring motor rotates the rotary induction plate.

The polarities of the induction magnets of the rotary induction plate that are adjacent to each other may be parallel to the rotation axis of the rotary induction plate and opposite to each other, and the polarities of the magnets of the stirring element that are adjacent to each other may be parallel to the rotation axis of the stirring element and opposite to each other. In this case, the plurality of induction magnets of the rotary induction plate and the plurality of magnets of the stirring element can be magnetically coupled to each other efficiently.

The polarities of the plurality of induction magnets of the rotary induction plate may be in directions along the concentric circle, and the polarities of the plurality of magnets of the stirring element may be parallel to the rotation axis of the stirring element. In this case, repulsive forces between the induction magnets and the magnets decrease. Thus, it is possible to suppress generation of noise, which may occur if the rotary induction plate continues rotating when the stirring element loses synchronism and the magnets of the stirring element and the induction magnets of the rotary induction plate attract and repel each other.

The stirring container may stir the liquid and a material by using the stirring element. In this case, it is possible to dissolve the material in the liquid and to stir the liquid.

The stirring device may be a milk preparation device that dissolves powdered milk in water.

According to an aspect A1 of the present invention, a stirring element 100A is a stirring element 100A that is used to stir a liquid L and a material (powdered milk PM) and that is to be placed on a bottom surface 51a of the stirring container 51. The stirring element 100A has a circular shape in plan view. The stirring element 100A includes a magnet 101 disposed therein and a first projecting portion (adaptation portion 106, projecting portion 102) that is disposed on a surface (back surface 103a) that faces the bottom surface 51a of the stirring container 51. The stirring element 100A is disposed concentrically with respect to the rotation center (rotation axis AX) of the stirring element 100A so as to surround the outer periphery of the protruding portion 52 that is disposed on the bottom surface 51a of the stirring container 51 and that has a circular shape in plan view.

With the structure described above, the magnet 101 is disposed in the stirring element 100A. Therefore, the stirring element 100A can rotate about the rotation axis AX as the magnet 101 is magnetically driven by a magnetic force from the stirring motor 40 disposed outside the stirring container 51. Thus, it is not necessary to provide a shaft that is connected to the stirring element and that rotates the stirring element. Therefore, it is possible to prevent mixing of bubbles into a beverage in the stirring container 51 due to the rotation of the shaft. Because the stirring element 100A need not have a shaft for rotating the stirring element, the stirring element 100A can be easily attached to and removed from the stirring container 51 and is highly convenient.

The stirring element 100A, having a circular shape in plan view, does not have a projection on a side surface and smoothly rotates. For example, compared with a bar-shaped stirring element, it is possible to suppress bubbling of a beverage.

The first projecting portion (adaptation portion 106, projecting portion 102) is disposed on the back surface 103a of the stirring element 100A concentrically with respect to the rotation axis AX of the stirring element 100A so as to surround the outer periphery of the protruding portion 52, which is disposed on the bottom surface 51a of the stirring container 51 and is circular in plan view. Thus, when the stirring element 100A rotates about the rotation axis AX, the first projecting portion (adaptation portion 106, projecting portion 102) and the protruding portion 52 together function structurally as a rotation shaft. Therefore, the stirring element 100A can stably rotate without being displaced from the rotation axis AX. Also in this respect, for example, compared with a bar-shaped stirring element, it is possible to suppress reduction of stirring ability while suppressing generation of bubbles in the beverage.

According to an aspect A2 of the present invention, in the stirring element 100A according to the aspect A1, preferably, the first projecting portion (adaptation portion 106) includes a plurality of projecting portions 102 that support the rotating stirring element 100A at three or more multiple points in such a way that the stirring element 100A is in contact with the protruding portion 52. With this structure, because the stirring element 100A includes the plurality of projecting portions 102, the stirring element is supported by the side surface of the protruding portion 52 at three or more multiple points. Therefore, detachment of the stirring element 100A from the protruding portion 52 can be prevented when the stirring element 100A rotates. Therefore, the stirring element 100A can rotate stably about the rotation axis AX.

According to an aspect A3 of the present invention, in the stirring element 100A according to the aspect A1 or A2, preferably, the magnet 101 is disposed in the first projecting portion (adaptation portion 106, projecting portion 102).

With this structure, the weight of the stirring element 100A increases due to the weight of the magnet 101, and the magnet 101 is magnetically coupled with a magnet of the stirring motor 40. Thus, it is possible to further rotate the stirring element 100A about the rotation axis AX. That is, the rotating stirring element 100A can be more reliably mounted on the protruding portion 52, and therefore it is possible to suppress generation of bubbles in the beverage that is being stirred and to more reliably stir the beverage.

In addition, by disposing the magnet 101 in the projecting portion 102, it is possible to dispose the magnet 101 so that a lower end portion of the magnet 101 surrounds the outer periphery of the protruding portion 52. Thus, it is possible to lower the center of gravity of the stirring element 100A and to rotate the stirring element 100A more stably.

According to an aspect A4 of the present invention, preferably, a stirring element 100B according to any one of the aspects A1 to A3 includes an upper-surface projecting portion (separator 105) that is disposed at a position on a surface (front surface 103b) opposite to a surface (back surface 103a) facing the bottom surface 51a of the stirring container 51 and on the rotation center (rotation axis AX). With this structure, when a user supplies a material (powdered milk PM) into the stirring container 51, the material (powdered milk PM) is supplied into the stirring container 51 so at to radially spread along the surface of the upper-surface projecting portion (separator 105). Thus, because generation of a lump of the material (powdered milk PM) in the stirring container 51 can be prevented, it is possible to prevent generation of an undissolved part of the material (powdered milk PM). Therefore, it is possible to efficiently dissolve the material (powdered milk PM).

According to an aspect A5 of the present invention, preferably, in a stirring element 100C, which is based on the stirring element 100B according to the aspect A4, the surface of the upper-surface projecting portion (separator 105C) has a plurality of recesses. With this structure, it is possible to further efficiently dissolve the material (powdered milk PM).

According to an aspect A6 of the present invention, preferably, in a stirring element 100D according to any one of the aspects A1 to A3, a surface (front surface 103Db) that is opposite to a surface (back surface 103Da) facing the bottom surface 51Da of the stirring container 51D gradually budges from an edge portion toward the rotation center (central portion 105D). With this structure, when a user places a material (powdered milk PM) into the stirring container 51D, the powdered milk PM can be efficiently distributed in the stirring container 51D while preventing the powdered milk PM from accumulating on the central portion 105D of the stirring element 100D. Therefore, it is possible to prevent generation of an undissolved part of the material (powdered milk PM). In addition, compared with a case where the front surface 103Db of the stirring element 100D has a flat shape, this structure is effective in reducing resistance of a water flow during stirring. Therefore, it is possible to further prevent generation of bubbles in the beverage.

According to an aspect A7 of the present invention, in the stirring element 100D according to the aspect A1, the first projecting portion (adaptation portion 106D) gradually bulges from an edge portion toward a portion that contacts the bottom surface 51Da of the stirring container 51D. With this structure, it is possible to reduce resistance of a water flow during stirring and to reduce frictional resistance between the stirring container 51D and the stirring element 100D.

According to an aspect A8 of the present invention, preferably, a mixing container (stirring unit 50) according to any one of the aspects A1 to A7 includes the stirring element 100A and a stirring container 51 in which the stirring element 100A is placed so as to cover the protruding portion 52 placed on the bottom surface 51a. With this structure, it is possible to obtain a mixing container (stirring unit 50) in which reduction of stirring ability is suppressed while suppressing generation of bubbles in the beverage.

According to an aspect A9 of the present invention, preferably, a beverage generating device (milk preparation device 1A) includes the mixing container (stirring unit 50) according to the aspect A8, and a stirring motor 40 that is disposed below a setting surface 2a of the mixing container (stirring unit 50) and that magnetically drives the stirring element 100A. With this structure, it is possible to obtain a beverage generating device (milk preparation device 1A) in which reduction of stirring ability is suppressed while suppressing generation of bubbles in the beverage.

The present invention is not limited to the embodiments described above and can be modified in various ways within the scope shown by the claims. The technical scope of the present invention also includes embodiments in which technical means disclosed in different embodiments are used in appropriate combinations. Moreover, it is possible to form a new technological feature by using combinations of the technical means disclosed in the embodiments.

### INDUSTRIAL APPLICABILITY

The present invention can be applied to a stirring element of a stirring unit of a beverage generating device, such as a milk preparation device, that can automatically generate a beverage in compliance with an appropriate milk preparation method while reducing generation of bubbles. To be specific, the present invention can be used for a stirring element that is used in a stirring unit that generates milk in which the amount of bubbles contained therein is reduced.

### REFERENCE SIGNS LIST

1A milk preparation device (beverage generating device, stirring device)
1E beverage generating device
2 milk preparation device body
2a setting surface (placement surface)
3 storage container
10 supply pipe
20 funnel
30 cooling portion
31 air inlet
32 fan
33A, 33B duct
34 air outlet
40 stirring motor (rotary drive unit)
41F, 41H to 41J rotary induction plate (rotary drive unit)
42F, 42H to 42J induction magnet
50, 50B to 50D, 50F, 50G, 50I, 50J stirring unit
51, 51D stirring container
51a, 51Da bottom surface (bottom portion)
52, 52D protruding portion (container-side protruding portion)
52F support portion
52Fa support curved surface (container-side top recessed portion)
52Fb upper surface guide (ring-shaped wall)
100, 100A to 100G, 100I stirring element
100, 100A to 100D, 100F, 100G, 100I, 100J stirring element
101, 101F, 101I magnet
102, 102F, 102I projecting portion (contact portion, first projecting portion, dot-shaped projecting portion)
103 plate portion
103D disc portion
103a, 103Da back surface (lower surface)
103b, 103Db front surface (upper surface)
105, 105C separator (upper-surface projecting portion)
105A, 105D central portion
106, 106D, 106F, 106I adaptation portion
107 axial curved surface (contact portion, stirring-element-side protruding portion)
108 ring (first ring-shaped projecting portion)
109 outer ring (second ring-shaped projecting portion)
500F to 500J stirring mechanism

1: A stirring element that is shaped like a disc and that is to be placed on a bottom portion of a stirring container for stirring a liquid,
wherein the stirring element is configured to perform rotational motion about a rotation center that is a center of the disc due to a magnetically acting force from outside,
wherein the stirring element comprises at least one projecting portion at a position on a lower surface of the stirring element separated from the rotation center, the lower surface facing the bottom portion of the stirring container and the projecting portion projecting toward the bottom portion of the stirring container, and
wherein an upper surface of the stirring element, which is opposite to the lower surface, is planar.

2: The stirring element according to claim 1, wherein a peripheral portion of the upper surface has a shape that is inclined downward toward an outer side.

3: The stirring element according to claim 2, wherein a central portion of the upper surface has a flat shape.

4: The stirring element according to claim 1, wherein the number of the projecting portions on the lower surface is three or more, and the projecting portions are disposed concentrically with respect to the rotation center.

5: The stirring element according to claim 1, wherein the projecting portion on the lower surface has an annular shape centered around the rotation center.

6: The stirring element according to claim 1, wherein the lower surface gradually bulges from an edge portion toward the projecting portion.

7: The stirring element according to claim 1, further comprising a magnet for receiving the magnetically acting force, at least a part of the magnet being disposed in the projecting portion.

8: The stirring element according to claim 1, wherein the upper surface gradually bulges from an edge portion toward the rotation center.

9: A stirring device comprising:
the stirring element according to claim 1; and
a stirring container in which the stirring element is placed.

10: The stirring device according to claim 9, wherein the stirring container includes a container-side protruding portion at a position on the bottom portion corresponding to the rotation center, the container-side protruding portion protruding toward the stirring element.

11: The stirring device according to claim 10, wherein the container-side protruding portion includes a container-side top recessed portion whose top is recessed,
wherein the stirring element includes a stirring-element-side protruding portion at a position facing the container-side protruding portion, the stirring-element-side protruding portion protruding toward the bottom portion of the stirring container, and
wherein a tip of the stirring-element-side protruding portion contacts an inner wall of the container-side top recessed portion.

12: The stirring device according to claim 10, wherein the stirring element includes a first ring-shaped projecting portion that projects from the lower surface toward the bottom portion of the stirring container so as to surround the container-side protruding portion of the stirring container.

13: The stirring device according to claim 12, wherein the stirring element includes at least one dot-shaped projecting portion on the lower surface at a position outside of the first ring-shaped projecting portion, the dot-shaped projecting portion projecting toward the bottom portion of the stirring container.

14: The stirring device according to claim 13, wherein the stirring element includes a second ring-shaped projecting portion that projects from the lower surface toward the bottom portion of the stirring container so as to surround the first ring-shaped projecting portion and the dot-shaped projecting portion.

15: The stirring device according to claim 9, wherein the stirring device has a placement surface on which the stirring container is placed, and the stirring device further comprises a rotary drive unit for rotating the stirring element by using the magnetically acting force.
